(19) United States
(12) Patent Application Publication
(10) Pub. No.: US 2008/0280953 A1
(43) Pub. Date: Nov. 13, 2008

(54) Agents Used for the Treatment of Seeds

(75) Inventors: Ulrich Gorgens, Ratingen (DE); Peter Jeschke, Bergisch Gladbach (DE); Peter Losel, Leverkusen (DE); Olga Malsam, Rosrath (DE); Ralf Nauen, Langenfeld (DE); Klaus-Gunter Tietjen, Langenfeld (DE); Robert Velten, Koln (DE); Leonardo Pitta, Leverkusen (DE); Christian Arnold, Langenfeld (DE); Waltraud Hempel, Liederbach (DE); Erich Sanwald, Kiel (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer Cropscience AG, Monheim (DE)

(21) Appl. No.: 11/576,355

(22) PCT Filed: Sep. 21, 2005
(86) PCT No.: PCT/EP2005/010196

§ 371 Date: Jan. 30, 2008

(30) Foreign Application Priority Data
Oct. 1, 2004 (DE) 102004047922.4

(51) Int. Cl. A01N 43/40; A01P 7/04

(52) U.S. Cl. 514/336

(57) ABSTRACT

The present invention relates to inter alia the use of known compounds for the treatment of seed.

The present application relates to the use of known active compounds for the treatment of seed.

It also relates to the control of plant zoopests by the application of known active compounds to the soil.

It relates further to the use of known active compounds for the control of certain plant pests.

The active compounds of structure (I)

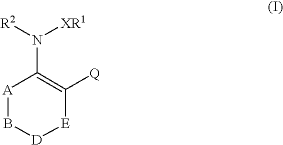

in which
R¹ stands for an unsubstituted or substituted 5- or 6-membered aromatic heterocyclic residue that contains nitrogen,
X stands for in each case unsubstituted or substituted alkylene or alkylidene
R² stands for hydrogen, for in each case unsubstituted or substituted alkyl, alkenyl, cycloalkyl, cycloalkenyl, aryl or for YR³,
Y stands for oxygen, S(O)₁, CO or CO₂,
   1 stands for 0, 1 or 2,
R³ stands for hydrogen or for in each case unsubstituted or substituted alkyl, alkenyl, alkynyl, cycloalkyl, cycloalkenyl or aryl,
A, B and D independently of each other stand for in each case an unsubstituted or substituted carbon atom or heteroatom or for a single bond,
E stands for CO or CS,
Q stands for hydrogen or for in each case unsubstituted or substituted alkyl, alkenyl, alkynyl or aryl or for nitro, halogen or for Z-R⁴,
Z stands for CO, CO² or S(O)ₘ,
m stands for 0, 1 or 2 and
R⁴ stands for in each case unsubstituted or substituted alkyl, alkenyl, alkynyl, cycloalkyl, cycloalkenyl or aryl
   and their preparation are known form EP 0 539 588 A1.

In detail the following compounds are cited in this publication:

TABLE 1

| | | |
|---|---|---|
| Compound | 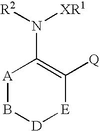 | Physical properties[ ]m.p. ° C.LC-MS; ¹H NMR(solvent) vinyl-H |

| No. | R₁—X | R₂ | —A—B—D | E | Q | [ppm] |
|---|---|---|---|---|---|---|
| 1 | 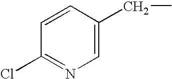 | H | —CH₂—CH₂—CH₂— | 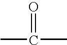 | H | [164-166] |
| 2 | 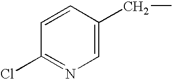 | CH₃ | —CH₂—CH₂—CH₂— | 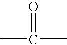 | H | [86-88] |
| 3 | 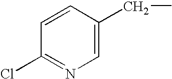 | C₂H₅ | —CH₂—CH₂—CH₂— | 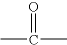 | H | ¹H NMR(CDCl₃): 5.22 |
| 4 | 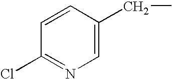 | n-C₃H₇ | —CH₂—CH₂—CH₂— | 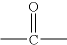 | H | ¹H NMR(CDCl₃): 5.20 |
| 5 | 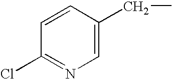 | i-C₃H₇ | —CH₂—CH₂—CH₂— | 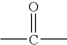 | H | |
| 6 | 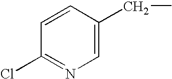 | 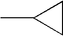 | —CH₂—CH₂—CH₂— | 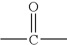 | H | |
| 7 | 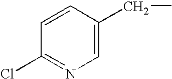 | 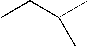 | —CH₂—CH₂—CH₂— | 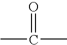 | H | n²⁵; _{D} 1.6005 |
| 8 | 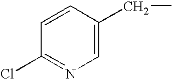 | 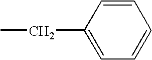 | —CH₂—CH₂—CH₂— | 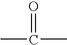 | H | |
| 9 | 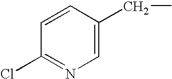 | CH₂CH═CH₂ | —CH₂—CH₂—CH₂— | 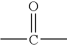 | H | ¹H NMR(CDCl₃): 5.26 |
| 10 | 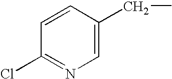 | CH₂C≡CH | —CH₂—CH₂—CH₂— | 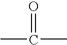 | H | ¹H NMR(CDCl₃): 5.34 |
| 11 | 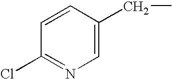 | OCH₃ | —CH₂—CH₂—CH₂— | 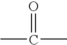 | H | [101-104] |
| 12 | 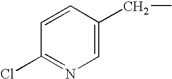 | COCH₃ | —CH₂—CH₂—CH₂— | 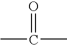 | H | |
| 13 | 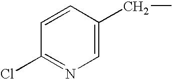 | COCF₃ | —CH₂—CH₂—CH₂— | 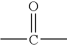 | H | n²⁵; _{D}1.5303 |
| 14 | 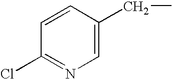 | 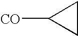 | —CH₂—CH₂—CH₂— | 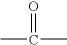 | H | |
| 15 | 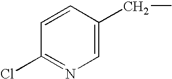 | SO₂CH₃ | —CH₂—CH₂—CH₂— | 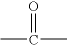 | H | |
| 16 | 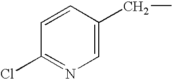 | 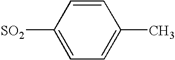 | —CH₂—CH₂—CH₂— | 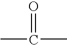 | H | |
| 17 | 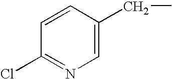 | H | —CH₂—CH₂—CH₂— | 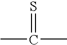 | H | [130-134] decomp. |
| 18 | 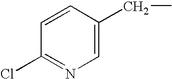 | CH₃ | —CH₂—CH₂—CH₂— | 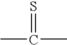 | H | |
| 19 | 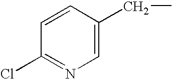 | H | —CH₂—CH₂—CH₂— | 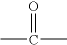 | CH₃ | [157-158] |
| 20 | 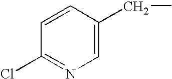 | H | —CH₂—CH₂—CH₂— | 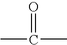 | CH₂CH═CH₂ | |
| 21 | 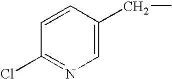 | H | —CH₂CH₂CH₂— | 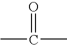 | CH₂C≡CH | |
| 22 | 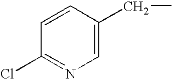 | H | —CH₂CH₂CH₂— | 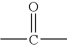 | 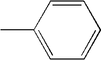 | |
| 23 | 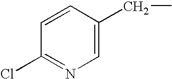 | H | —CH₂CH₂CH₂— | 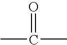 | Cl | [160-161] |
| 24 | 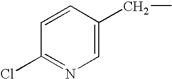 | H | —CH₂CH₂CH₂— | 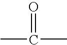 | NO₂ | n²⁵; _{D}1.5908 |
| 25 | 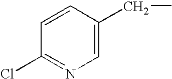 | H | —CH₂CH₂CH₂— | 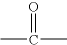 | CN | |
| 26 | 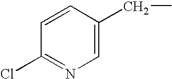 | H | —CH₂CH₂CH₂— | 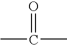 | COCH₃ | |
| 27 | 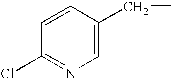 | H | —CH₂CH₂CH₂— | 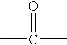 | COCF₃ | n²⁵; _{D}1.5225 |
| 28 | 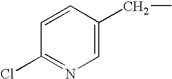 | H | —CH₂CH₂CH₂— | 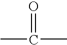 | SO₂CH₃ | |
| 29 | 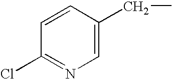 | H | 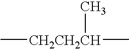 | 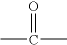 | H | [200-201] |
| 30 | 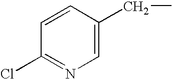 | H | 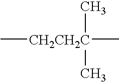 | 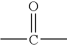 | H | [193-195] |
| 31 | 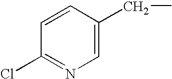 | H | 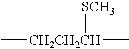 | 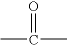 | H | [180-182] decomp. |
| 32 | 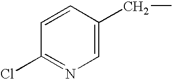 | H | 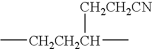 | 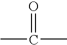 | H | [176-177] |
| 33 | 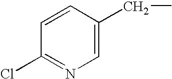 | H | 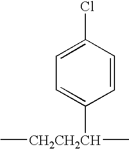 | 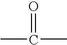 | H | [241-243] |
| 34 | 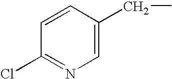 | H | 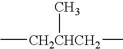 | 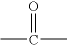 | H | [176-177] |
| 35 | 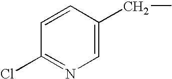 | H | 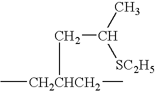 | 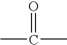 | H | [137-138] |
| 36 | 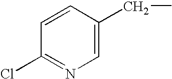 | H | 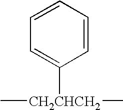 | 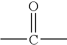 | H | [216-217] |
| 37 | 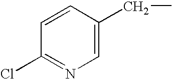 | H | 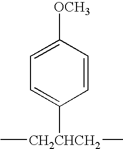 | 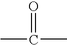 | H | [210-211] |
| 38 | 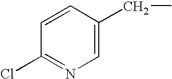 | H | 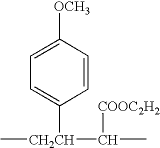 | 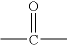 | H | [224-226] |
| 39 | 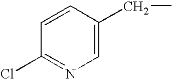 | H | 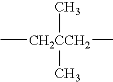 | 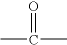 | H | [199-201] |
| 40 | 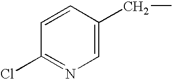 | H | 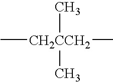 | 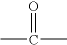 | NO₂ | [181-183] |
| 41 | 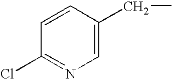 | H | 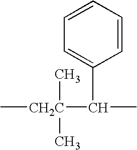 | 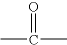 | H | [182-183] |
| 42 | 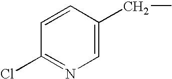 | CH₃ | 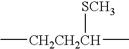 | 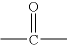 | H | [108-110] |
| 43 | 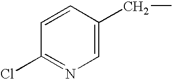 | CH₃ | 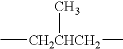 | 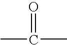 | H | n²⁵; _{D}1.5992 |
| 44 | 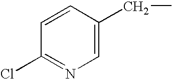 | H | 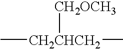 | 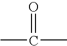 | H | [139-140] |
| 45 | 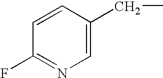 | H | —CH₂CH₂CH₂— | 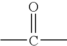 | H | |
| 46 | 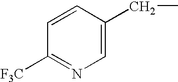 | H | —CH₂CH₂CH₂— | 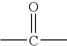 | H | |
| 47 | 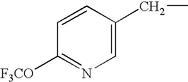 | H | —CH₂CH₂CH₂— | 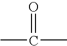 | H | |
| 48 | 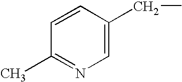 | H | —CH₂CH₂CH₂— | 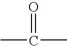 | H | |
| 49 | 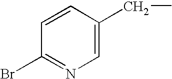 | H | —CH₂CH₂CH₂— | 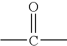 | H | |
| 50 | 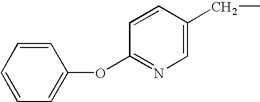 | H | —CH₂CH₂CH₂— | 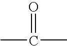 | H | |
| 51 | 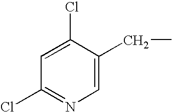 | H | —CH₂CH₂CH₂— | 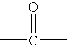 | H | |
| 52 | 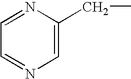 | H | —CH₂CH₂CH₂— | 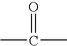 | H | |
| 53 | 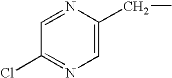 | H | —CH₂CH₂CH₂— | 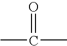 | H | |
| 54 | 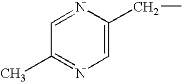 | H | —CH₂CH₂CH₂— | 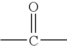 | H | |
| 55 | 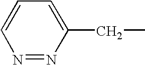 | H | —CH₂CH₂CH₂— | 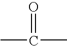 | H | |
| 56 | 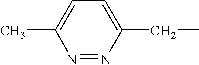 | H | —CH₂CH₂CH₂— | 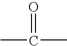 | H | |
| 57 | 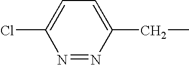 | H | —CH₂CH₂CH₂— | 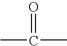 | H | |
| 58 | 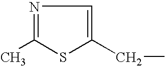 | H | —CH₂CH₂CH₂— | 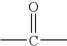 | H | |
| 59 | 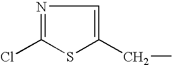 | H | —CH₂CH₂CH₂— | 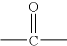 | H | [144-146] |
| 60 | 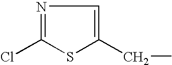 | CH₃ | —CH₂CH₂CH₂— | 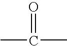 | H | n²⁵; _{D}1.6208 |
| 61 | 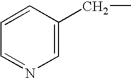 | H | —CH₂CH₂CH₂— | 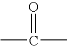 | H | [73-76] |
| 62 | 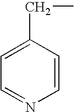 | H | —CH₂CH₂CH₂— | 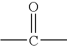 | H | |
| 63 | 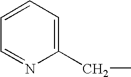 | H | —CH₂CH₂CH₂— | 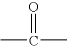 | H | |
| 64 | 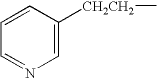 | H | —CH₂CH₂CH₂— | 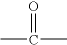 | H | |
| 65 | 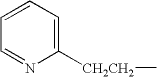 | H | —CH₂CH₂CH₂— | 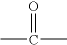 | H | |
| 66 | 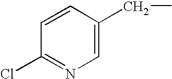 | H | —CH₂CH₂NH— | 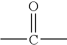 | H | [191-192] |
| 67 | 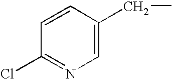 | H | 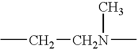 | 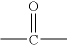 | H | |
| 68 | 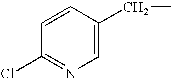 | H | 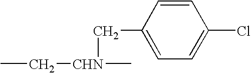 | 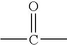 | H | [154-156] |
| 69 | 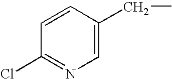 | H | 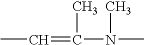 | 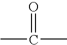 | NO₂ | n²⁵; _{D}^{1.4972} |
| 70 | 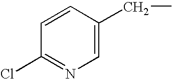 | H | 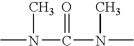 | 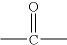 | H | [122-123] |
| 71 | 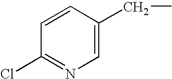 | H | 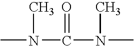 | 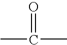 | NO₂ | [147-148] |
| 72 | 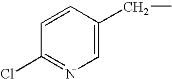 | H | 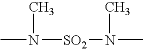 | 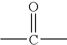 | H | [159-160] |
| 73 | 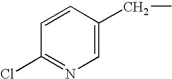 | H | 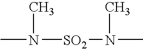 | 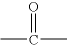 | NO₂ | [210-211] |
| 74 | 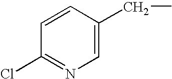 | H | —CH₂—CH₂—O— | 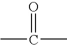 | H | [189-190] |
| 75 | 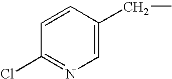 | H | 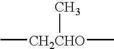 | 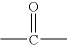 | H | [143-144] |
| 76 | 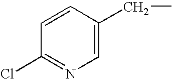 | H | 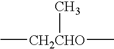 | 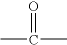 | NO₂ | [152-154] |
| 77 | 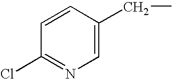 | H | 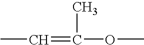 | 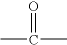 | H | [173-175] |
| 78 | 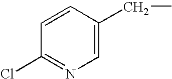 | H | 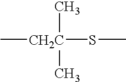 | 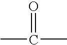 | H | [205-207] |
| 79 | 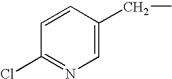 | H | 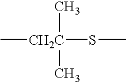 | 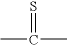 | H | [153-155] decomp. |
| 80 | 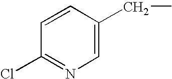 | H | —CH₃SCH₂— | 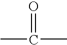 | H | [217-218] |
| 81 | 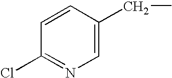 | H | 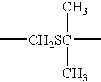 | 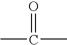 | H | [196-197] |
| 82 | 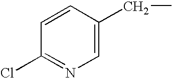 | CH₃ | —CH₂CH₂O— | 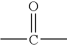 | H | [viscose oil] |
| 83 | 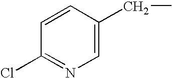 | H | —CH₂O— | 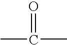 | H | [136-138] |
| 84 | 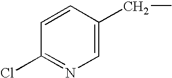 | CH₃ | —CH₂O— | 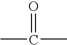 | H | [105-107] |
| 85 | 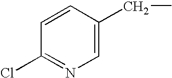 | C₂H₅ | —CH₂O— | 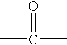 | H | [103-104] |
| 86 | 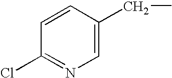 | n-C₃H₇ | —CH₂O— | 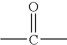 | H | [97-100] |
| 87 | 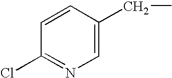 | i-C₃H₇ | —CH₂O— | 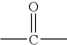 | H | MH⁺ 267.1 (100);¹H NMR(CDCl₃): 4.55 |
| 88 | 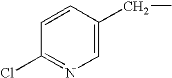 | 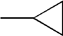 | —CH₂O— | 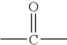 | H | [89-92] |
| 89 | 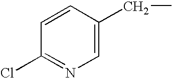 | 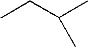 | —CH₂O— | 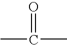 | H | n²⁵; _{D}1.5725 |
| 90 | 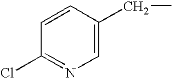 | 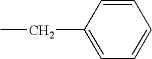 | —CH₂O— | 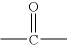 | H | MH⁺ 315.1 (100);¹H NMR(d3-acetonitrile):4.70 |
| 91 | 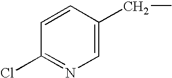 | CH₂CH═CH₂ | —CH₂O— | 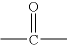 | H | [78-79] |
| 92 | 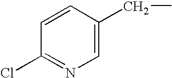 | CH₂—C≡CH | —CH₂O— | 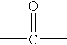 | H | MH⁺ 263.0 (100);¹H NMR(d3-acetonitrile):4.90 |
| 93 | 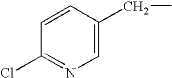 | CONHCH₃ | —CH₂O— | 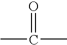 | H | [183-191] |
| 94 | 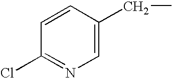 | COCH₃ | —CH₂O— | 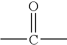 | H | MH⁺ 267.0 (100);¹H NMR(CDCl₃): 5.18 |
| 95 | 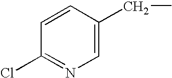 | COCF₃ | —CH₂O— | 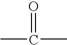 | H | |
| 96 | 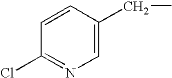 | 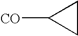 | —CH₂O— | 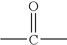 | H | [161-164] |
| 97 | 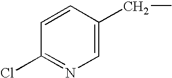 | SO₂CH₃ | —CH₂O— | 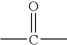 | H | |
| 98 | 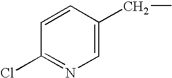 | OCH₃ | —CH₂O— | 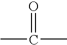 | H | [128-129] |
| 99 | 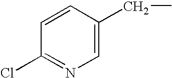 | H | —CH₂O— | 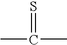 | H | |
| 100 | 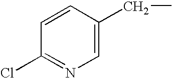 | CH₃ | —CH₂O— | 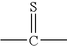 | H | |
| 101 | 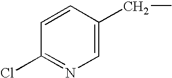 | H | —CH₂O— | 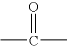 | CH₃ | |
| 102 | 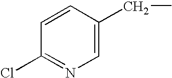 | H | —CH₂O— | 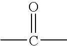 | Cl | |
| 103 | 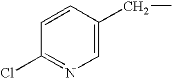 | H | —CH₂O— | 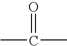 | Br | [144-145] |
| 104 | 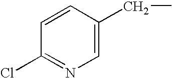 | CH₃ | —CH₂O— | 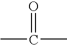 | F | [100-103] |
| 105 | 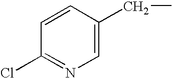 | 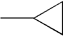 | —CH₂O— | 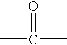 | F | [81-83] |
| 106 | 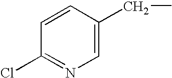 | H | —CH₂O— | 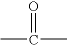 | NO₂ | [218-220] |
| 107 | 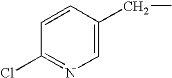 | H | —CH₂O— | 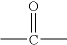 | CN | |
| 108 | 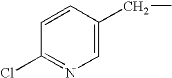 | H | —CH₂O— | 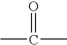 | SO₂CH₃ | [191-192] |
| 109 | 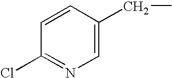 | H | —CH₂O— | 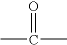 | COCH₃ | |
| 110 | 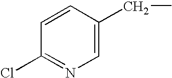 | H | —CH₂O— | 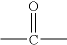 | COCF₃ | [173-176] decomp. |
| 111 | 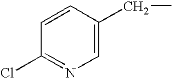 | H | —CH₂S— | 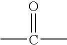 | H | [183-184] |
| 112 | 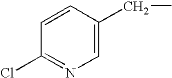 | CH₃ | —CH₂S— | 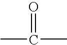 | H | [104-105]MH⁺ 255 (100);Rt = 3.10**Rt (in min) (0.1%HCOOH/MeCN); cf.WO 02085870 A |
| 113 | 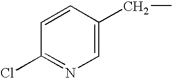 | C₂H₅ | —CH₂S— | 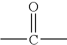 | H | MH⁺ 269 (100);Rt = 3.61**Rt (in min) (0.1%HCOOH/MeCN); cf.WO 02085870 A |
| 114 | 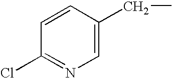 | 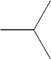 | —CH₂S— | 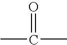 | H | |
| 115 | 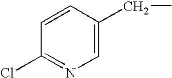 | 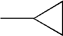 | —CH₂S— | 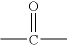 | H | |
| 116 | 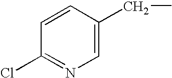 | H | 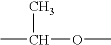 | 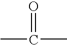 | H | [157-158] |
| 117 | 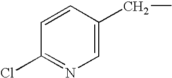 | CH₃ | 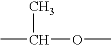 | 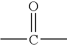 | H | n²⁵; _{D}1.5737 |
| 118 | 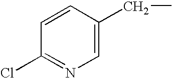 | CH₃ | 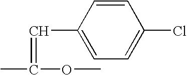 | 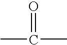 | H | [78-80] |
| 119 | 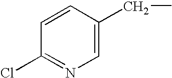 | CH₃ | 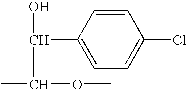 | 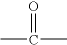 | H | [195-198] |
| 120 | 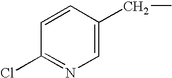 | CH₃ | 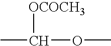 | 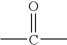 | H | [118-121] |
| 121 | 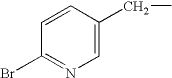 | CH₃ | —CH₂O— | 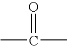 | H | MH⁺ 283.0 (100);¹H NMR(d3-acetonitrile):4.64 |
| 122 | 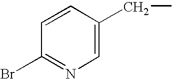 | 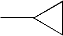 | —CH₂O— | 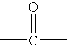 | H | |
| 123 | 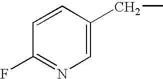 | CH₃ | —CH₂O— | 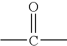 | H | MH⁺ 223.1 (100);¹H NMR(d3-Acetonitril):4.75 |
| 124 | 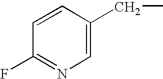 | 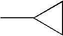 | —CH₂O— | 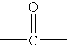 | H | MH⁺ 249.1 (100);¹H NMR(d3-acetonitrile):4.75 |
| 125 | 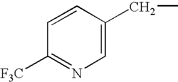 | CH₃ | —CH₂O— | 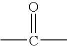 | H | MH⁺ 273.1 (100);¹H NMR(d3-acetonitrile):4.64 |
| 126 | 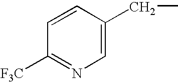 | 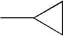 | —CH₂O— | 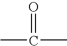 | H | MH⁺ 299.1 (100);¹H NMR(d3-acetonitrile):4.72 |
| 127 | 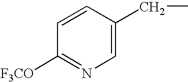 | CH₃ | —CH₂O— | 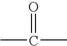 | H | |
| 128 | 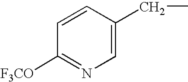 | 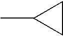 | —CH₂O— | 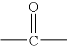 | H | |
| 129 | 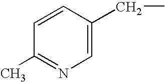 | CH₃ | —CH₂O— | 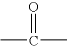 | H | |
| 130 | 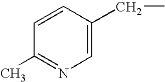 | 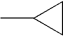 | —CH₂O— | 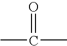 | H | |
| 131 | 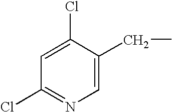 | CH₃ | —CH₂O— | 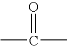 | H | |
| 132 | 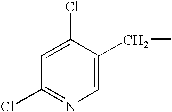 | 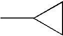 | —CH₂O— | 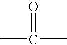 | H | |
| 133 | 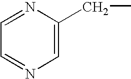 | CH₃ | —CH₂O— | 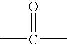 | H | |
| 134 | 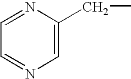 | 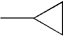 | —CH₂O— | 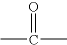 | H | |
| 135 | 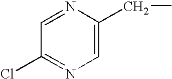 | CH₃ | —CH₂O— | 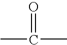 | H | |
| 136 | 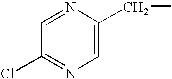 | 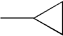 | —CH₂O— | 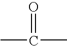 | H | |
| 137 | 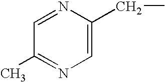 | CH₃ | —CH₂O— | 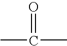 | H | |
| 138 | 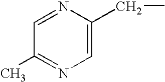 | 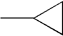 | —CH₂O— | 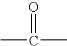 | H | |
| 139 | 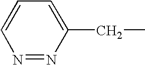 | CH₃ | —CH₂O— | 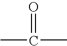 | H | |
| 140 | 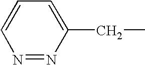 | 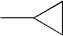 | —CH₂O— | 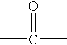 | H | |
| 141 | 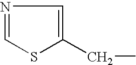 | CH₃ | —CH₂O— | 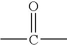 | H | |
| 142 | 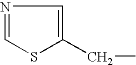 | 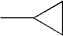 | —CH₂O— | 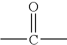 | H | |
| 143 | 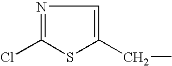 | H | —CH₂O— | 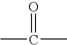 | H | [143-145] |
| 144 | 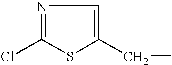 | CH₃ | —CH₂O— | 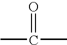 | H | n²⁵; _{D}1.6035 |
| 145 | 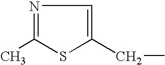 | CH₃ | —CH₂O— | 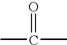 | H | |
| 146 | 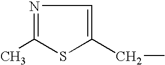 | 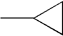 | —CH₂O— | 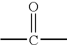 | H | |
| 147 | 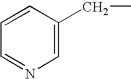 | CH₃ | —CH₂O— | 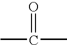 | H | MH⁺ 205.1 (100);¹H NMR(d3-acetonitrile):4.63 |
| 148 | 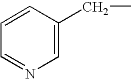 | 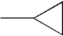 | —CH₂O— | 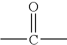 | H | |
| 149 | 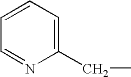 | CH₃ | —CH₂O— | 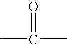 | H | |
| 150 | 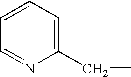 | 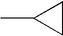 | —CH₂O— | 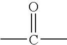 | H | |
| 151 | 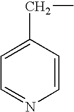 | CH₃ | —CH₂O— | 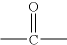 | H | |
| 152 | 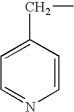 | 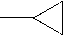 | —CH₂O— | 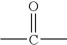 | H | |
| 153 | 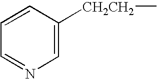 | CH₃ | —CH₂O— | 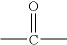 | H | |
| 154 | 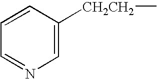 | 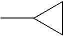 | —CH₂O— | 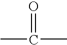 | H | |
| 155 | 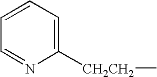 | CH₃ | —CH₂O— | 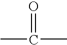 | H | |
| 156 | 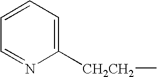 | 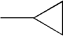 | —CH₂O— | 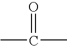 | H | |
| 157 | 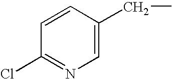 | H | —CH₂NH— | 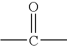 | H | [194-200] decomp. |
| 158 | 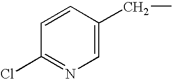 | CH₃ | —CH₂NH— | 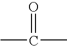 | H | [193-198] decomp. |
| 159 | 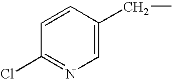 | H | 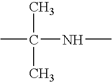 | 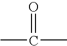 | H | [214-215] |
| 160 | 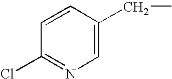 | CH₃ | 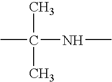 | 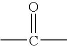 | H | [147-148] |
| 161 | 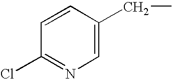 | H | 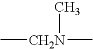 | 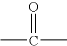 | H | [192-193] decomp. |
| 162 | 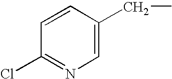 | CH₃ | 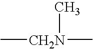 | 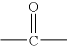 | H | [114-115] |
| 163 | 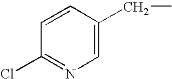 | H | 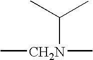 | 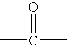 | H | [223-226] decomp. |
| 164 | 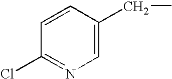 | CH₃ | 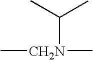 | 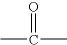 | H | [101-102] |
| 165 | 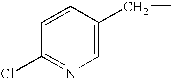 | CH₃ | 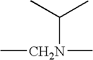 | 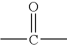 | 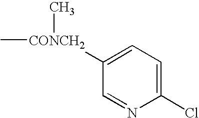 | [133-136] |
| 166 | 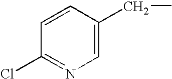 | n-C₃H₇ | —CH₂NH— | 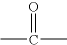 | H | |
| 167 | 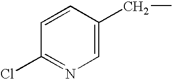 | i-C₃H₇ | —CH₂NH— | 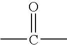 | H | |
| 168 | 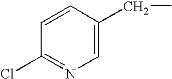 | 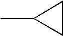 | —CH₂NH— | 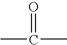 | H | MH⁺ 264.0 (100);¹H NMR(d6-DMSO): 4.77 |
| 169 | 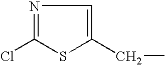 | CH₃ | —CH₂NH— | 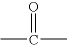 | H | MH⁺ 244.0 (100);¹H NMR(d6-DMSO): 4.80 |
| 170 | 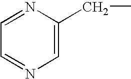 | CH₃ | —CH₂NH— | 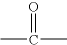 | H | |
| 171 | 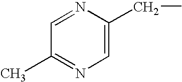 | CH₃ | —CH₂NH— | 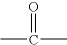 | H | |
| 172 | 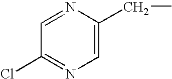 | CH₃ | —CH₂NH— | 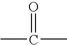 | H | |
| 173 | 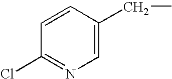 | CH₃ | —CH₂NH— | 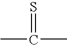 | H | |
| 174 | 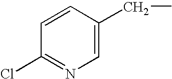 | H | —CH₂CH₂— | 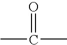 | H | [173-175] |
| 175 | 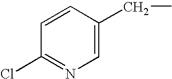 | CH₃ | —CH₂CH₂— | 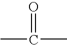 | H | n²⁵; _{D}1.6092 |
| 176 | 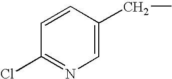 | C₂H₅ | —CH₂CH₂— | 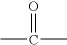 | H | |
| 177 | 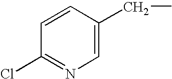 | n-C₃H₇ | —CH₂CH₂— | 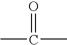 | H | |
| 178 | 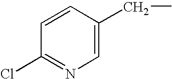 | i-C₃H₇ | —CH₂CH₂— | 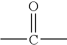 | H | |
| 179 | 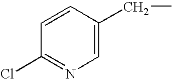 | 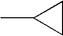 | —CH₂CH₂— | 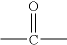 | H | MH⁺ 263.1 (100);¹H NMR(d6-DMSO): 5.05 |
| 180 | 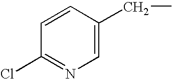 | COCH₃ | —CH₂CH₂— | 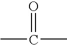 | H | |
| 181 | 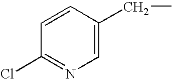 | SO₂CH₃ | —CH₂CH₂— | 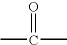 | H | |
| 182 | 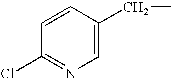 | CH₃ | —CH₂CH₂— | 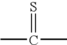 | H | |
| 183 | 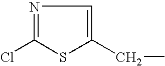 | CH₃ | —CH₂CH₂— | 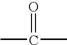 | H | |
| 184 | 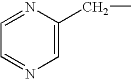 | CH₃ | —CH₂CH₂— | 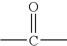 | H | |
| 185 | 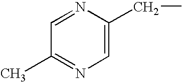 | CH₃ | —CH₂CH₂— | 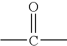 | H | |
| 186 | 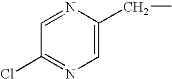 | CH₃ | —CH₂CH₂— | 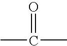 | H | |
| 187 | 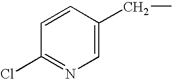 | CH₃ | —CH₂CH₂— | 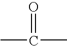 | CH₃ | [174-175] |
| 188 | 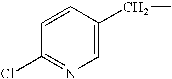 | H | —CH₂CH₂— | 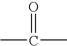 | NO₂ | [165-167] |

It is further known from EP 0 539 588 A1 that the compounds of structure (I) show good activity against army worm, cabbage moth, aphids, cicada and the brown plant hopper.

It has now been found that the known compounds of structure (I) are especially suitable for the treatment of seed.

A great deal of the damage on cultigens caused by pests occurs by the infestation of seed during storage and after application of the seed to the earth as well as during and immediately after germination of the plants. This phase is particularly critical since the roots and the shoots are especially sensitive, and even slight damage can lead to death of the plant. There is therefore considerable interest in protecting the seed and the germinating plants by the use of suitable agents.

The control of pests by treatment of the seed of plants has been known for a long time and is the subject of ongoing improvement. However, there is a series of problems in the treatment of seed that cannot always be solved satisfactorily. Thus it is worthwhile to develop methods for the protection of seed and the germinating plants that make the additional application of plant protection agents after seeding or emergence of the plant superfluous. It is also worthwhile to optimise the amount of active compound used to the effect that the seed and the germinating plant is protected against pest infestation as best possible without damaging the plant itself by the active compound used. In particular methods for the treatment of seed should also include the intrinsic insecticidal properties of transgenic plants in order to achieve an optimal protection of the seed and the germinating plant with minimal application of plant protection agents.

Thus the present invention relates in particular to a method for the protection of seed and germinating plants from attack by pests in that the seed is treated with the compounds of structure (I). The invention relates also to the use of the compounds of structure (I) for the treatment of seed to protect the seed and the germinating plants for protection against pests. In addition the invention relates to seed that has been treated with a compound of structure (I) for protection against pests.

One of the advantages of the present invention is that owing to the special systemic properties of the compounds of structure (I), the treatment of seed with these compounds protects not only the seed itself against pests on sowing, but also the emerging plants from pests after sowing. In this way the direct treatment of the culture at the time of sowing or shortly thereafter can be omitted.

It may also be considered advantageous that the compounds of structure (I) can also be used especially with transgenic seed, whereby the plants emerging from these seeds are able to express a protein directed against these pests. By the treatment of such seed with the compounds of structure (I) certain pests can already be controlled by the expression of the, for example, insecticidal protein, and moreover surprisingly a synergistic activity supplementation arises with the compounds of structure (I) which improves further the effectiveness of the protection against pests.

The compounds of structure (I) are suitable for the treatment of all plant varieties such as those already mentioned that are used in agriculture, greenhouses, forests, in market gardening and horticulture, and vineyards. In particular this relates to the seed of maize, peanut, canola, rape, poppy, olive, coconut, cacao, soy, cotton, beet (e.g. sugar beet and forage beet), rice, sorghum, wheat, barley, oats, rye, sunflower, sugar cane or tobacco. The compounds of structure (I) are also suitable for the treatment of the seed of fruit plants and vegetables, as previously mentioned. Special importance is attached to the treatment of the seed of maize, soy, cotton, wheat and canola or rape.

As already mentioned, special importance is attributed to the treatment of transgenic seed with compounds of structure (I). This relates to the treatment of seeds of plants that usually contain at least one heterologous gene that controls the expression of a polypeptide with in particular insecticidal properties. The heterologous genes in transgenic seed can originate from microorganisms such as Bacillus, Rhizobium, Pseudomonas, Serratia, Trichoderma, Clavibacter, Glomus or Gliocladium. The present invention is particularly suitable for the treatment of transgenic seed that contains at least one heterologous gene that comes from Bacillus sp. and whose gene product exhibits activity against the corn borer and/or corn root worm. Particular preference is given to a heterologous gene from Bacillus thuringiensis.

Within the context of the present invention the compound of structure (I) is applied to the seed alone or in a suitable formulation. The seed is treated preferably at a time point at which it is so stable that no damage occurs during treatment. In general treatment of the seed can take place at any time between harvest and sowing. Normally seed is used that is separated from the plant and freed from spadix, husk, stem, pod, wool or fruit flesh.

In general care must be taken during treatment of seed that the amount of compound of structure (I) and/or further additives applied is so selected that the germination of the seed is not impaired and the emerging plant is not damaged. This is primarily to be noted with active compounds that can show phytotoxic effects when applied in certain amounts.

The compounds of structure (I) can be applied directly, that is without containing further components and without being diluted. It is usually preferred to apply the agent to the seed in the form of a suitable formulation. Suitable formulations and methods for seed treatment are known to the person skilled in the art and are described, for example, in the following documents: U.S. Pat. No. 4,272,417 A, U.S. Pat. No. 4,245,432 A, U.S. Pat. No. 4,808,430 A, U.S. Pat. No. 5,876,739 A, US 2003/0176428 A1, WO 2002/080675 A1, WO 2002/028186A2.

The seed dressings of the invention are suitable for the control of zoopests, particularly arthropods and nematodes, especially insects and arachnids, that occur in agriculture and forestry. They are active against normally sensitive and resistant species as well as against all or individual development stages. The pests cited above include:

the order of Anoplura (Phthiraptera) e.g. Damalinia spp., Haematopinus spp., Linognathus spp., Pediculus spp., Trichodectes spp.,
the class of Arachnida e.g. Acarus siro, Aceria sheldoni, Aculops spp., Aculus spp., Amblyomma spp., Argas spp., Boophilus spp., Brevipalpus spp., Bryobia praetiosa, Chorioptes spp., Dermanyssus gallinae, Eotetranychus spp., Epitrimerus pyri, Eutetranychus spp., Eriophyes spp., Hemitarsonemus spp., Hyalomma spp., Ixodes spp., Latrodectus mactans, Metatetranychus spp., Oligonychus spp., Ornithodoros spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vasates lycopersici,
the class of Bivalva e.g. Dreissena spp.,
the order of Chilopoda e.g. Geophilus spp., Scutigera spp.,
the order of Coleoptera e.g. Acanthoscelides obtectus, Adoretus spp., Agelastica alni, Agriotes spp., Amphimallon solstitialis, Anobium punctatum, Anoplophora spp., Anthonomus spp., Anthrenus spp., Apogonia spp., Atomaria spp., Attagenus spp., Bruchidius obtectus, Bruchus spp., Ceuthorhynchus spp., Cleonus mendicus, Conoderus spp., Cosmopolites spp., Costelytra zea-landica, Curculio spp., Cryptorhynchus lapathi, Dermestes spp., Diabrotica spp., Epilachna spp., Faustinus cubae, Gibbium psylloides, Heteronychus arator, Hylamorpha elegans, Hylotrupes bajulus, Hypera postica, Hypothenemus spp., Lachnostema consanguinea, Leptinotarsa decemlineata, Lissorhoptrus oryzophilus, Lixus spp., Lyctus spp., Meligethes aeneus, Melolontha melolontha, Migdolus spp., Monochamus spp., Naupactus xanthographus, Niptus hololeucus, Oryctes rhinoceros, Oryzaephilus surinamensis, Otiorrhynchus sulcatus, Oxycetonia jucunda, Phaedon cochleariae, Phyllophaga spp., Popillia japonica, Premnotrypes spp., Psylliodes chryso-cephala, Ptinus spp., Rhizobius ventralis, Rhizopertha dominica, Sitophilus spp., Sphenophorus spp., Stemechus spp., Symphyletes spp., Tenebrio molitor, Tribolium spp., Trogoderma spp., Tychius spp., Xylotrechus spp., Zabrus spp.,
the order of Collembola e.g. Onychiurus armatus,
the order of Dermaptera e.g. Forficula auricularia,
the order of Diplopoda e.g. Blaniulus guttulatus,
the order of Diptera e.g. Aedes spp., Anopheles spp., Bibio hortulanus, Calliphora erythrocephala, Ceratitis capitata, Chrysomyia spp., Cochliomyia spp., Cordylobia anthropophaga, Culex spp., Cuterebra spp., Dacus oleae, Dermatobia hominis, Drosophila spp., Fannia spp., Gastrophilus spp., Hylemyia spp., Hyppobosca spp., Hypoderma spp., Liriomyza spp. Lucilia spp., Musca spp., Nezara spp., Oestrus spp., Oscinella frit, Pegomyia hyoscyami, Phorbia spp., Stomoxys spp., Tabanus spp., Tannia spp., Tipula paludosa, Wohlfahrtia spp.,
the class of Gastropoda e.g. Arion spp., Biomphalaria spp., Bulinus spp., Deroceras spp., Galba spp., Lymnaea spp., Oncomelania spp., Succinea spp.,
the class of helminths e.g. Ancylostoma duodenale, Ancylostoma ceylanicum, Acylostoma braziliensis, Ancylostoma spp., Ascaris lubricoides, Ascaris spp., Brugia malayi, Brugia timori, Bunostomum spp., Chabertia spp., Clonorchis spp., Cooperia spp., Dicrocoelium spp, Dictyocaulus filaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp, Strongyloides fuellebomi, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichuria, Wuchereria bancrofti,

In addition protozoa such as Eimeria may be controlled.

The order of Heteroptera e.g. Anasa tristis, Antestiopsis spp., Blissus spp., Calocoris spp., Campylomma livida, Cavelerius spp., Cimex spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Nezara spp., Oebalus spp., Pentomidae, Piesma quadrata, Piezodorus spp., Psallus seriatus, Pseudacysta persea, Rhodnius spp., Sahlbergella singularis, Scotinophora spp., Stephanitis nashi, Tibraca spp., Triatoma spp.,

the order of Homoptera e.g. Acyrthosipon spp., Aeneolamia spp., Agonoscena spp., Aleurodes spp., Aleurolobus barodensis, Aleurothrixus spp., Amrasca spp., Anuraphis cardui, Aonidiella spp., Aphanostigma piri, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Doralis spp., Drosicha spp., Dysaphis spp., Dysmicoccus spp., Empoasca spp., Eriosoma spp., Erythroneura spp., Euscelis bilobatus, Geococcus coffeae, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva fimbriolata, Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes vaporariorum, Trioza spp., Typhlocyba spp., Unaspis spp., Viteus vitifolii,
the order of Hymenoptera e.g. Diprion spp., Hoplocampa spp., Lasius spp., Monomorium pharaonis, Vespa spp.,
the order of Isopoda e.g. Armadillidium vulgare, Oniscus asellus, Porcellio scaber,
The order Isoptera e.g. Reticulitermes spp., Odontotermes spp.,
the order of Lepidoptera e.g. Acronicta major, Aedia leucomelas, Agrotis spp., Alabama argillacea, Anticarsia spp., Barathra brassicae, Bucculatrix thurberiella, Bupalus piniarius, Cacoecia podana, Capua reticulana, Carpocapsa pomonella, Chematobia brumata, Chilo spp., Choristoneura fumiferana, Clysia ambiguella, Cnaphalocerus spp., Cydia pomonella, Earias insulana, Ephestia kuehniella, Euproctis chrysorrhoea, Euxoa spp., Feltia spp., Galleria mellonella, Helicoverpa spp., Heliothis spp., Hofmannophila pseudospretella, Homona magnanima, Hyponomeuta padella, Laphygma spp., Lithocolletis blancardella, Lithophane antennata, Loxagrotis albicosta, Lymantria spp., Malacosoma neustria, Mamestra brassicae, Mocis repanda, Mythimna separata, Oria spp., Oulema oryzae, Panolis flammea, Pectinophora gossypiella, Phyllocnistis citrella, Pieris spp., Plutella xylostella, Prodenia spp., Pseudaletia spp., Pseudoplusia includens, Pyrausta nubilalis, Spodoptera spp., Thermesia gemmatalis, Tinea pellionella, Tineola bisselliella, Tortrix viridana, Trichoplusia spp.,
the order of Orthoptera e.g. Acheta domesticus, Blatta orientalis, Blattella germanica, Gryllotalpa spp., Leucophaea maderae, Locusta spp., Melanoplus spp., Periplaneta americana, Schistocerca gregaria,

the order of Siphonaptera e.g. Ceratophyllus spp., Xenopsylla cheopis,

the order of Symphyla e.g. Scutigerella immaculata,
the order of Thysanoptera e.g. Baliothrips biformis, Enneothrips flavens, Frankliniella spp., Heliothrips spp., Hercinothrips femoralis, Kakothrips spp., Rhipiphorothrips cruentatus, Scirtothrips spp., Taeniothrips cardamoni, Thrips spp.,
the order of Thysanura e.g. Lepisma saccharina.

The plant parasitic nematodes include e.g. Anguina spp., Aphelenchoides spp., Belonoaimus spp., Bursaphelenchus spp., Ditylenchus dipsaci, Globodera spp., Heliocotylenchus spp., Heterodera spp., Longidorus spp., Meloidogyne spp., Pratylenchus spp., Radopholus similis, Rotylenchus spp., Trichodorus spp., Tylenchorhynchus spp., Tylenchulus spp., Tylenchulus semipenetrans, Xiphinema spp.

With the aid of the dressing of the invention the following orders of insects are preferably controllable:

Soil insects: Diptera (e.g. frit fly, bulb fly), Coleoptera (e.g. Diabrotica, wire worm), Lepidoptera (e.g. turnip moth), Blattophtheroidea, Myriopoda.
Leaf insects: Aphidina, Coleoptera, Brachycera, Lepidotera, Homoptera, Tysanoptera, Aleurodina, Cicadina, Acasi, Cossina, Heteroptera.

It was also surprisingly found that the compounds of structure (I) possess systemic properties and applied above ground exhibit a very good activity against the above-mentioned zoopests.

Here granulates that contain the active compound(s) are advantageously applied into or onto the soil. Suitable are for example broadcast, strip, furrow and divot application. By broadcast application is meant surface application of the active compound over the whole of the surface to be treated followed by the mechanical incorporation into the soil.

In particular the use in plant boxes (seed boxes) in rice cultivation (nursery box treatment) is mentioned.

Particularly advantageous is to emulsify or dissolve the compounds of structure (I) or their salts in water and use this to water the plants.

Suitable are spraying onto the soil, drenching, that is wetting the plants with solutions containing the active compound and drip irrigation as well as the use of hydrocultures, especially in vegetable and ornamental plants.

The compounds of structure (I) can also be applied through the stem, for example by stem injection.

It was further found that the compounds of structure (I) are exceptionally suitable for the control of the house fly.

According to the invention the compounds of structure (I) can be used in the control of cockroaches, that is insects of the order Blattariae, especially the family Blattellidae, particularly the species Blattella germanica or the family Blattidae, particularly the species Blatta orientalis and Periplaneta americana and also against other cockroach species, most particularly, however, against Blattella germanica.

According to the invention the compound of structure (I) acts upon cockroaches is such a way that the repellent action of insecticides, e.g. of pyrethroids, is reduced.

This effect occurs in all mobile development stages (larvae, adults) of cockroaches. Para-hydroxyphenylacetic acid and/or its mixtures with other chemical compounds can thus be used quite generally in cockroach control, independently of the type of control method used. In can be preferably used in chemical control methods and optionally together with other active agents such as attractant bait material or other attractants, synthetic or natural insecticides, etc.

By simple deliberation and simple investigations it is easily possible for the person skilled in the art to determine the suitable mixtures and types of application and amounts for the respective use.

It was further found that the known compounds of structure (I) are also excellent for the control of pests that are not mentioned in EP 0 539 588 (army worm, cabbage moth, aphids, cicada and brown plant hopper).

The compounds of structure (I) are preferably used for the control of pests described in the examples.

It has also been found that the compounds of the invention are not only active against plant, hygiene and storage pests but also against zoopests in the veterinary sector (ectoparasites and endoparasites) such as hard ticks, soft ticks, mange ticks, harvest mites, flies (stinging and licking), parasitic fly larvae, lice, biting mites, chewing mites and fleas. These parasites include:

the order Anoplurida e.g. Haematopinus spp., Linognathus spp., Pediculus spp., Phtirus spp., Solenopotes spp.,
the order Mallophagida and the suborders Amblycerina and Ischnocerina e.g. Trimenopon spp., Menopon spp., Trinoton spp., Bovicola spp., Werneckiella spp., Lepikentron spp., Damalina spp., Trichodectes spp., Felicola spp.,
the order Diptera and the suborders Nematocerina and Brachycerina e.g. Aedes spp., Anopheles spp., Culex spp., Simulium spp., Eusimulium spp., Phlebotomus spp., Lutzomyia spp., Culicoides spp., Chrysops spp., Hybomitra spp., Atylotus spp., Tabanus spp., Haematopota spp., Philipomyia spp., Braula spp., Musca spp., Hydrotaea spp., Stomoxys spp., Haematobia spp., Morellia spp., Fannia spp., Glossina spp., Calliphora spp., Lucilia spp., Chrysomyia spp., Wohlfahrtia spp., Sarcophaga spp., Oestrus spp., Hypoderma spp., Gasterophilus spp., Hippobosca spp., Lipoptena spp., Melophagus spp.,
the order Siphonapterida e.g. Pulex spp., Ctenocephalides spp., Xenopsylla spp., Ceratophyllus spp.,
the order Heteropterida e.g. Cimex spp., Triatoma spp., Rhodnius spp., Panstrongylus spp.,
the order Blattarida e.g. Blatta orientalis, Periplaneta americana, Blattela germanica, Supella spp.,
the subclass Acari (Acarina) and the order Meta- and Mesostigmata e.g. Argas spp., Ornithodorus spp., Otobius spp., Ixodes spp., Amblyomma spp., Boophilus spp., Dermacentor spp., Haemophysalis spp., Hyalomma spp., Rhipicephalus spp., Dermanyssus spp., Raillietia spp., Pneumonyssus spp., Sternostoma spp., Varroa spp.,
the order Actinedida (Prostigmata) and Acaridida (Astigmata) e.g. Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp., Laminosioptes spp.

The compounds of the invention of structure (I) are also suitable for the control of arthropods that affect agricultural animals such as cattle, sheep, goats, horses, pigs, donkeys, camels, buffalo, rabbits, chickens, turkeys, ducks, geese, bees, miscellaneous domestic animals such as dogs, cats, cage birds, aquarium fish as well as so-called experimental animals such as hamsters, guinea pigs, rats and mice. By control of these arthropods death rates and performance loss (in meat, milk, wool, hides, eggs, honey, etc.) will be reduced so that more economic and simpler animal husbandry is possible by the use of the compounds of the invention.

The use of the active compounds of structure (I) in the veterinary sector and animal husbandry is carried out by known means, by enteric administration in the form of, for example, tablets, capsules, drinks, drenches, granulates, pastes, boluses, the feed-through process, suppositories, by parenteral administration by, for example, injection (intramuscular, subcutaneous, intravenous, intraperitoneal, amongst others), implants, by nasal application, by dermal use in the form of, for example, dipping, spraying, pour-on and spot-on, washing, powdering and with the help of appliances containing the active compound such as collars, ear markers, tail markers, limb bands, halters, marking devices, etc.

During use in cattle, poultry, pets, etc., the active compounds can be used as formulations (for example, powder, emulsions, flowable agents) that contain the active compounds in an amount of 1 to 80 wt. %, directly or after 100 to 10,000 times dilution or as a chemical bath.

Moreover it has been found that the compounds of structure (1) of the invention exhibit high insecticidal action against insects that destroy technical materials.

As example and preferably—but not limiting—the following insects are named:

beetles such as
Hylotrupes bajulus, Chlorophorus pilosis, Anobium punctatum, Xestobium rufovillosum, Ptilinus pecticornis, Dendrobium pertinex, Ernobius mollis, Priobium carpini, Lyctus brunneus, Lyctus africanus, Lyctus planicollis, Lyctus linearis, Lyctus pubescens, Trogoxylon aequale, Minthes rugicollis, Xyleborus spec. Tryptodendron spec. Apate monachus, Bostrychus capucins, Heterobostrychus brunneus, Sinoxylon spec. Dinoderus minutes,
hymenoptera such as
Sirex juvencus, Urocerus gigas, Urocerus gigas taignus, Urocerus augur,
termites such as
Kalotermes flavicollis, Cryptotermes brevis, Heterotermes indicola, Reticulitermes flavipes, Reticulitermes santonensis, Reticulitermes lucifugus, Mastotermes darwiniensis, Zootermopsis nevadensis, Coptotermes formosanus, Odontoteremes formosanus Odontoteremes lokanandi, Odontoteremes obesus, Odontoteremes smeatmani,
silverfish such as
Lepisma saccharina.

Within the present context technical materials are understood to mean non-living materials such as preferably plastics, adhesives, glues, paper and cardboard, leather, wood, wood fabrication products and paints.

The most preferred materials to be protected from insect infestation are wood and wood fabrication products.

Wood and wood fabrication products that can be protected by the agents of the invention or mixtures containing them are understood to be, for example:

timber, wooden beams, railway sleepers, bridge parts, boat landing stages, wooden vehicles, crates, palettes, containers, telephone posts, panels, wooden windows and doors, plywood, chipboard, carpentry work or wood products normally used in house building or carpentry.

The active compounds of structure (I) can be applied as such, in the form of concentrates or commonly used formulations such as powders, granulates, solutions, suspensions, emulsions or pastes.

The named formulations can be prepared by known methods, for example by mixing the active compounds with at least one solvent or diluent, emulsifier, dispersant and/or bonding or fixing agent, water repellents, optionally siccatives and UV stabilisers and optionally colorants and pigments as well as further processing auxiliaries.

The insecticidal agents or concentrates for the protection of wood or wood fabrication products contain the active compound of the invention in a concentration of 0.0001 to 95 wt. %, especially 0.001 to 60 wt. %.

The amount of agent or concentrate used is dependent upon the species and occurrence of the insects and upon the medium. The optimal amount used can in each case be determined by test series during use. In general it is sufficient, however, to use 0.0001 to 20 wt. %, preferably 0.001 to 10 wt. % of the active compound relative to the material to be protected.

An organic solvent or solvent mixture and/or an oily or oil-like, low volatility organic solvent or solvent mixture and/or a polar organic solvent or solvent mixture and/or water and optionally an emulsifier and/or wetting agent serves as solvent or diluent.

Preferably oily or oil-like solvents with an evaporation number above 35 and a flash point above 30° C., preferably above 45° C., are used as organic solvent. Commensurate mineral oils or their aromatic fractions or solvent mixtures containing mineral oil are used as such low volatility, water insoluble, oily and oil-like solvents, preferably white spirits, petroleum and/or alkylbenzene.

Mineral oils with a boiling range of 170 to 220° C., white spirits with a boiling range of 170 to 220° C., spindle oil with a boiling range of 250 to 350° C., petroleum or aromatics with a boiling range of 160 to 280° C., turpentine oil and the like have been used to advantage.

In a preferred embodiment liquid aliphatic hydrocarbons with a boiling range of 180 to 210° C. or high boiling mixtures of aromatic and aliphatic hydrocarbons with a boiling range of 180 to 220° C. and/or spindle oil and/or monochloronaphthaline, preferably α-monochloronaphthaline, are used.

The low volatility oily or oil-like organic solvents with an evaporation number above 35 and a flash point above 30° C., preferably above 45° C., can be replaced in part by high or medium volatility organic solvents with the criterion that the solvent mixture also has an evaporation number above 35 and a flash point above 30° C., preferably above 45° C., and that the insecticidal-fungicidal mixture is soluble or emulsifiable in this solvent mixture.

According to a preferred embodiment a part of the organic solvent or solvent mixture is replaced by an aliphatic polar organic solvent or solvent mixture. Preferably aliphatic organic solvents containing hydroxy and/or ester and/or ether groups, for example glycol ethers, esters or the like are used.

Within the scope of the present invention the known synthetic resins and/or bonding drying oils that are water-dilutable and/or soluble or dispersible or emulsifiable in the organic solvents used, especially bonding agents consisting of or containing an acrylic resin, a vinyl resin, for example polyvinyl acetate, polyester resin, polycondensation or polyaddition resin, polyurethane resin, alkyd resin or modified alkyd resin, phenolic resin, hydrocarbon resin such as indene-coumarone resin, silicon resin, drying vegetable and/or drying oils and/or physically drying bonding agents based on a natural and/or synthetic resin are used as organic bonding agents.

The artificial resin used as bonding agent can be used in the form of an emulsion, dispersion or solution. Bitumens or bituminous compounds up to 10 wt. % can also be used as bonding agents. In addition known colorants, pigments, water repellents, odour correctants and inhibitors or corrosion protectants and the like can be used.

Preferably according to the invention at least one alkyd resin or modified alkyd resin and/or drying vegetable oil is contained in the agent or concentrate as organic bonding agent. Preferably according to the invention alkyd resins with an oil content of more than 45 wt. %, preferably 50 to 68 wt. % are used.

The bonding agent described can be completely or partially replaced by a fixing agent (mixture) or a plasticizer (mixture). These additives prevent volatilisation as well as crystallisation or precipitation of the active compound. Preferably they replace 0.01 to 30% of the bonding agent (relative to 100% of the bonding agent used).

The plasticizers come from the chemical class of the phthalate esters such as dibutyl, dioctyl or benzylbutyl phthalate, phosphate esters such as tributyl phosphate, adipate esters such as di(2-ethylhexyl) adipate, stearates such as butyl stearate or amyl stearate, oleates such as butyl oleate, glycerol ethers or higher molecular glycol ethers, glycerol esters as well as p-toluenesulphonic acid esters.

Fixing agents are based chemically on polyvinylalkyl ethers such as, for example, polyvinylmethyl ether or ketones such as benzophenone, ethylenebenzophenone.

Water is also especially suitable as solvent or diluent, optionally in admixture with one or more of the above mentioned organic solvents or diluents, emulsifiers and dispersants.

A particularly effective wood protection is obtained by industrial scale impregnation processes, for example vacuum, double vacuum or pressure processes.

The ready-to-use agent can optionally contain further insecticides and optionally also one or more fungicides.

At the same time the compounds of structure (I) can be used as protection against growth on objects, especially ships' hulls, screens, nets, buildings, quays and signal equipment that come into contact with sea or brackish water.

Growth from sessile oligochaetes, such as fan worms, as well as shell fish and species of the Ledamorpha group (goose barnacles), such as different Lepas and Scalpellum species, or through species of the group Balanomorpha (acom barnacles) such as Balanus or Pollicipes Species, increase the frictional resistance of ships and consequently lead to increased energy consumption and moreover to a considerable increase in operating costs through frequent dry docking.

In addition to the growth of algae, for example Ectocarpus sp. and Ceramium sp., the growth of sessile Entomostraca groups in particular those that are grouped under the name Cirripedia (barnacle) are of special significance.

It has now been surprisingly found that the compounds of the invention alone or in combination with other active compounds exhibit an excellent antifouling action.

By the use of the compounds of structure (I) the use of heavy metals such as in bis(trialkyltin) sulphides, tri-n-butyltin laurate, tri-n-butyltin chloride, copper(I) oxide, triethyltin chloride, tri-n-butyl(2-phenyl-4-chlorophenoxy)tin, tributyltin oxide, molybdenum disulphide, antimony oxide, polymeric butyl titanate, phenyl(bispyridine)bismuth chloride, tri-n-butyltin fluoride, manganese ethylene bisthiocarbamate, zinc dimethyl bisthiocarbamate, zinc ethylene bisthiocarbamate, zinc and copper salts of 2-pyridinethiol-1-oxide, bisdimethylbisthiocarbamoylzinc ethylene bisthiocarbamate, zinc oxide, copper(I) ethylene bisdithiocarbamate, copper thiocyanate, copper naphthenate and tributyltin halides can be avoided or the concentration of these compounds decisively reduced.

The ready-to-use antifouling paints can optionally contain other active compounds, preferably algaecides, fungicides, herbicides, molluscicides or other active anti-fouling compounds.

Suitable combination partners for the anti-fouling agents of the invention are preferably: algaecides such as:

2-tert.-butylamino-4-cyclopropylamino-6-methylthio-1,3,5-triazine, dichlorophene, diuron, endothal, fentin acetate, isoproturon, methabenzthiazuron, oxyfluorfen, quinoclamine and terbutryn,
fungicides such as
benzo[b]thiophene-S,S-dioxide cyclohexylamide, dichlofluanid, fluorfolpet, 3-iodo-2-propynyl butylcarbamate, tolylfluanid and azoles such as azaconazole, cyproconazole, epoxyconazole, hexaconazole, metconazole, propiconazole and tebuconazole,
molluscicides such as
Fe chelating agents, fentin acetate, metaldehyde, methiocarb, niclosamide, ethripole and trimethacarb,
or conventional active antifouling compounds such as
4,5-dichloro-2-octyl-4-isothiazolin-3-one, diiodomethylparatryl sulphone, 2-(N,N-dimethylthio-carbamoylthio)-5-nitrothiazyl, potassium, copper, sodium and zinc salts of 2-pyridinethiol-1-oxide, pyridine triphenylborane, tetrabutyldistannoxane, 2,3,5,6-tetrachloro-4-(methylsulphonyl)pyridine, 2,4,5,6-tetrachloroisophthalonitrile, tetramethylthiuram disulfide and 2,4,6-trichlorophenyl-maleiimide.

The antifouling agents used contain the active compound at a concentration of 0.001 to 50 wt. %, especially 0.01 to 20 wt. %.

The antifouling agents contain in addition the usual components as described in, for example, Ungerer, Chem. Ind. 1985, 37, 730-732 und Williams, Antifouling Marine Coatings, Noyes, Park Ridge, 1973.

In addition to algaecides, fungicides, molluscicides and active insecticidal compounds, antifouling paints contain in particular bonding agents.

Examples of recognised bonding agents are polyvinyl chloride in a solvent system, chlorinated rubber in a solvent system, acrylic resins in a solvent system especially in an aqueous system, vinyl chloride/vinyl acetate copolymer systems in the form of aqueous dispersions or in the form of organic solvent systems, butadiene/styrene/acrylonitrile rubbers, drying oils, such as linseed oil, resin esters or modified resin esters in combination with tar or bitumen, asphalt as well as epoxy compounds, small amounts of chlorinated rubber, chlorinated polypropylene and vinyl resins.

Optionally paints also contain inorganic pigments, organic pigments or colorants that are preferably insoluble in sea water. In addition the paints can contain materials such as rosin in order to allow a controlled release of the active compound. The paints can also contain plasticizers, agents that modify the rheological properties as well as other conventional components. The active compound combinations of the invention of the invention can also be incorporated into self-polishing anti-fouling systems.

The compounds of structure (I) are also suitable for the control of zoopests, especially insects, arachnids and mites that occur in enclosed spaces such as apartments, factory halls, offices, vehicle cabins, etc. They can be used alone or in combination with other active compounds and auxiliaries in domestic insecticidal products to control these pests. They are effective against sensitive and resistant species as well as all development stages. These pests include:

the order Scorpionidea e.g. Buthus occitanus,
the order Acarina e.g. Argas persicus, Argas reflexus, Bryobia ssp., Dermanyssus gallinae, Glyciphagus domesticus, Ornithodorus moubat, Rhipicephalus sanguineus, Trombicula alfreddugesi, Neutrombicula autumnalis, Dermatophagoides pteronissimus, Dermatophagoides forinae,
the order Araneae e.g. Aviculariidae, Araneidae,
the order Opiliones e.g. Pseudoscorpiones chelifer, Pseudoscorpiones cheiridium, Opiliones phalangium,
the order Isopoda e.g. Oniscus asellus, Porcellio scaber,
the order Diplopoda e.g. Blaniulus guttulatus, Polydesmus spp.,
the order Chilopoda e.g. Geophilus spp.,
the order Zygentoma e.g. Ctenolepisma spp., Lepisma saccharina, Lepismodes inquilinus,
the order Blattaria e.g. Blatta orientalies, Blattella germanica, Blattella asahinai, Leucophaea maderae, Panchlora spp., Parcoblatta spp., Periplaneta australasiae, Periplaneta americana, Periplaneta brunnea, Periplaneta fuliginosa, Supella longipalpa,
the order Saltatoria e.g. Acheta domesticus,
the order Dermaptera e.g. Forficula auricularia,
the order Isoptera e.g. Kalotermes spp., Reticulitermes spp.,
the order Psocoptera e.g. Lepinatus spp., Liposcelis spp.,
the order Coleoptera e.g. Anthrenus spp., Attagenus spp., Dermestes spp., Latheticus oryzae, Necrobia spp., Ptinus spp., Rhizopertha dominica, Sitophilus granarius, Sitophilus oryzae, Sitophilus zeamais, Stegobium paniceum,
the order Diptera e.g. Aedes aegypti, Aedes albopictus, Aedes taeniorhynchus, Anopheles spp., Calliphora erythrocephala, Chrysozona pluvialis, Culex quinquefasciatus, Culex pipiens, Culex tarsalis, Drosophila spp., Fannia canicularis, Musca domestica, Phlebotomus spp., Sarcophaga camaria, Simulium spp., Stomoxys calcitrans, Tipula paludosa,
the order Lepidoptera e.g. Achroia grisella, Galleria mellonella, Plodia interpunctella, Tinea cloacella, Tinea pellionella, Tineola bisselliella,
the order Siphonaptera e.g. Ctenocephalides canis, Ctenocephalides felis, Pulex irritans, Tunga penetrans, Xenopsylla cheopis,
the order Hymenoptera e.g. Camponotus herculeanus, Lasius fuliginosus, Lasius niger, Lasius umbratus, Monomorium pharaonis, Paravespula spp., Tetramorium caespitum,
the order Anoplura e.g. Pediculus humanus capitis, Pediculus humanus corporis, Phthirus pubis,
the order Heteroptera e.g. Cimex hemipterus, Cimex lectularius, Rhodinus prolixus, Triatoma infestans.

The use in the domestic insecticide sector is carried out alone or in combination with other suitable active compounds such as phosphate esters, carbamates, pyrethroids, neonicotinoids, growth regulators or other active compounds from other known classes of insecticides.

Application is carried out with aerosols, non-pressurised spray agents, e.g. pump and dusting sprays, nebulisers, foggers, foamers, gels, evaporation products with evaporation platelets of cellulose or plastic, liquid evaporators, gel and membrane evaporators, propeller-driven evaporators, non-energy or passive evaporation systems, fly papers, fly traps, and fly gels, as granulates or dusts, in scatter bait or bait stations.

During use of the active compound combinations of the invention the amount applied can be varied over a large range according to the type of application. In the treatment of plant parts the amounts of active compound combination applied lies generally between 0.1 and 10,000 g/ha, preferably between 10 and 1,000 g/ha.

The good insecticidal activity of the compounds of structure (I) is illustrated in the following examples.

### EXAMPLE A

Bemisia tabaci test (normal sensitive strain)

| | |
|---|---|
| Solvent: | 7 parts by weight dimethylformamide |
| Emulsifier: | 10 parts by weight alkylarylpolyglycol ether |

To prepare a suitable active compound preparation 1 part by weight of the active compound is mixed with the given amount of solvent and emulsifier and the concentrate is diluted to the desired concentration with water containing emulsifier.

Cotton plants (Gossypium hirsutum) that are infested with eggs, larvae and pupae of the white fly (Bemisia tabaci) are treated by, spraying with the active compound preparation at the desired concentration.

After the desired time the death rate in % is determined. Here 100% means that all animals were killed; 0% means that no animals were killed.

The following compound of the preparation examples, for example, shows good activity in this test:

TABLE A
Plant damaging insects
Bemisia tabaci test (normal sensitive strain)

| | Active | |
|---|---|---|
| | compound | Death rate |
| Active | concentration | in % |
| compound | in ppm | after 14^{d} |
| 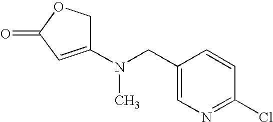 | 100 | 100 |
| according to the invention (84) | | |

### EXAMPLE B

Bemisia tabaci test (resistant strain)

| | |
|---|---|
| Solvent: | 10 parts by weight acetone |
| Emulsifier: | 0.2 parts by weight Triton X-100 |

To prepare a suitable active compound preparation 1 part by weight of the active compound is mixed with the given amount of solvent and emulsifier and the concentrate is diluted to the desired concentration with water containing emulsifier.

Leaf sections of the cotton plant (Gossypium hirsutum) are treated by dipping in the active compound preparation at the desired concentration and after drying of the coating are infected with adults of the white fly (Bemisia tabaci, resistant strain).

After the desired time the death rate in % is determined. Here 100% means that all animals were killed; 0% means that no animals were killed.

The following compound of the preparation examples, for example, shows good activity in this test:

TABLE B
Plant damaging insects
Bemisia tabaci test (resistant strain)

| | Active | |
|---|---|---|
| | compound | Death rate |
| Active | concentration | in % |
| compound | in ppm | after 3^{d} |
| 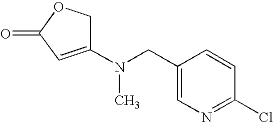 | 1000 | 78 |
| according to the invention (84) | | |

### EXAMPLE C

Liriomyza trifolii test

| | |
|---|---|
| Solvent: | 7 parts by weight dimethylformamide |
| Emulsifier: | 10 parts by weight alkylarylpolyglycol ether |

To prepare a suitable active compound preparation 1 part by weight of the active compound is mixed with the given amount of solvent and emulsifier and the concentrate is diluted to the desired concentration with water containing emulsifier.

Kidney bean plants (Phaseolus vulgaris) that are infected with the larvae of the leafminer fly (Liriomyza trifolii) are treated by spraying with the active compound mixture at the desired concentration.

After the desired time the activity in % is determined. Here 100% means that no leafminer tracks can be seen; 0% means that the experimental plants are comparable to the controls.

The following compounds of the preparation examples, for example, show good activity in this test:

TABLE C
Plant damaging insects
Liriomyza trifolii test

| | Active | |
|---|---|---|
| | compound | Activity |
| Active | concentration | in % |
| compounds | in ppm | after 7^{d} |
| 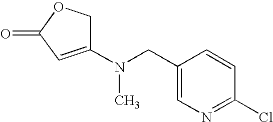 | 100 | 46 |
| according to the invention (84) | | |
| 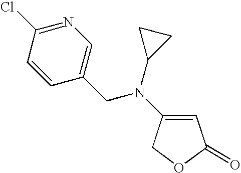 | 100 | 55 |
| according to the invention (84) | | |

### EXAMPLE D

Frankliniella occidentalis test

| | |
|---|---|
| Solvent: | 7 parts by weight dimethylformamide |
| Emulsifier: | 10 parts by weight alkylarylpolyglycol ether |

To prepare a suitable active compound preparation 1 part by weight of the active compound is mixed with the given amount of solvent and emulsifier and the concentrate is diluted to the desired concentration with water containing emulsifier.

Cotton plants (Gossypium hirsutum) are treated by spraying with the active compound preparation at the desired concentration and infected with a mixed thrips population (Frankliniella occidentalis).

After the desired time the activity in % is determined. Here 100% means that all thrips were killed; 0% means that no thrips were killed.

The following compounds of the preparation examples, for example, show good activity in this test:

TABLE D
Plant damaging insects
Frankliniella occidentalis test

| | Active | |
|---|---|---|
| | compound | Activity |
| Active | concentration | in % |
| compounds | in ppm | after 14^{d} |
| 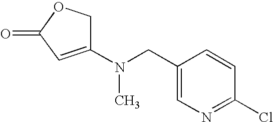 | 100 | 99 |
| according to the invention (84) | | |
| 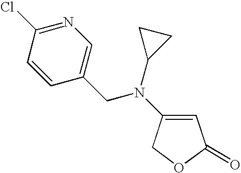 | 100 | 99 |
| according to the invention (88) | | |

### EXAMPLE E

Leptinotarsa decemlineata larvae test

| | |
|---|---|
| Solvent: | 7 parts by weight dimethylformamide |
| Emulsifier: | 10 parts by weight alkylarylpolyglycol ether |

To prepare a suitable active compound preparation 1 part by weight of the active compound is mixed with the given amount of solvent and emulsifier and the concentrate is diluted to the desired concentration with water containing emulsifier.

Leaves of potato plants (Solanum tuberosum) that are infested with the larvae of the Colorado beetle (Leptinotarsa decemlineata) are treated by spraying with the active compound preparation at the desired concentration.

After the desired time the activity in % is determined. Here 100% means that all beetle larvae were killed; 0% means that no beetle larvae were killed.

The following compounds of the preparation examples, for example, show good activity in this test:

TABLE E
Plant damaging insects
Leptinotarsa decemlineata larvae test

| | Active | |
|---|---|---|
| | compound | Activity |
| Active | concentration | in % |
| compounds | in g ai/ha | after 6^{d} |
| 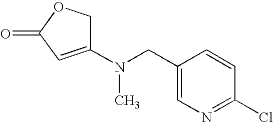 | 60 | 100 |
| according to the invention (84) | | |
| 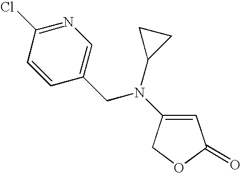 | 60 | 100 |
| according to the invention (88) | | |

### EXAMPLE F

Aphis gossypii test (soil application)

| | |
|---|---|
| Solvent: | 4 parts by weight acetone |
| Emulsifier: | 1 part by weight alkylarylpolyglycol ether |

To prepare a suitable active compound preparation 1 part by weight of the active compound is mixed with the given amount of solvent and emulsifier and the concentrate is diluted to the desired concentration with water.

The active compound mixture was mixed with soil. The concentration given refers to amount of active compound per volume unit of soil (mg/l=ppm). Pots are filled with the treated earth and planted with a cotton plant (Gossypium hirsutum). After one week the plants are infected with the cotton aphid (Aphis gossypii).

After the desired time the death rate in % is determined. Here 100% means that all aphids were killed; 0% means that no aphids were killed.

The following compounds of the preparation examples, for example, show good activity in this test:

TABLE F
Plant damaging insects
Alphis gossypii (soil application)

| | Active | |
|---|---|---|
| | compound | Activity |
| Active | concentration | in % |
| compounds | in ppm | after 7^{d} |
| 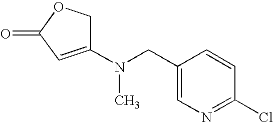 | 4 | 100 |
| according to the invention (84) | | |
| 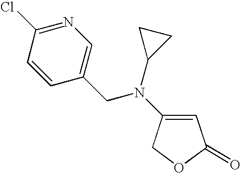 | 4 | 100 |
| according to the invention (88) | | |

### EXAMPLE G

Myzus persicae test (soil application)

| | |
|---|---|
| Solvent: | 4 parts by weight acetone |
| Emulsifier: | 1 part by weight alkylarylpolyglycol ether |

To prepare a suitable active compound preparation 1 part by weight of the active compound is mixed with the given amount of solvent and emulsifier and the concentrate is diluted to the desired concentration with water.

The active compound mixture was mixed with soil. The concentration given refers to amount of active compound per volume unit of earth (mg/l=ppm). Pots are filled with the treated earth and planted with a pepper plant (Capsicum annuum). After a week they are infected with the green peach aphid (Myzus persicae).

After the desired time the death rate in % is determined. Here 100% means that all aphids were killed; 0% means that no aphids were killed.

The following compounds of the preparation examples, for example, show good activity in this test:

TABLE G
Plant damaging insects
Myzus persicae (soil application)

| | Active | |
|---|---|---|
| | compound | Activity |
| Active | concentration | in % |
| compounds | in ppm | after 7^{d} |
| 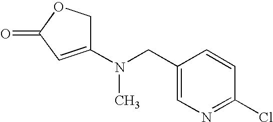 | 4 | 100 |
| according to the invention (84) | | |
| 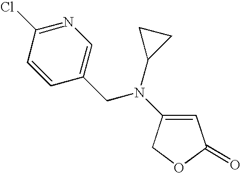 | 4 | 100 |
| according to the invention (88) | | |

### EXAMPLE H

Diabrotica balteata larvae test (soil application)

| | |
|---|---|
| Solvent: | 4 parts by weight acetone |
| Emulsifier: | 1 part by weight alkylarylpolyglycol ether |

To prepare a suitable active compound preparation 1 part by weight of the active compound is mixed with the given amount of solvent and emulsifier and the concentrate is diluted to the desired concentration with water.

The active compound mixture was mixed with soil. The concentration given refers to amount of active compound per volume unit of earth (mg/l=ppm). Pots are filled with the treated earth and planted with 5 maize seeds per pot. 3 days after seeding larvae of the corn root worm (Diabrotica balteata) were placed in the treated soil.

After the desired time the death rate in % is determined. The level of activity is determined by the number of emerging plants

The following compound of the preparation examples, for example, shows good activity in this test:

TABLE H
Plant damaging insects
Diabrotica balteata (soil application)

| | Active | |
|---|---|---|
| | compound | Activity |
| Active | concentration | in % |
| compounds | in ppm | after 4^{d} |
| 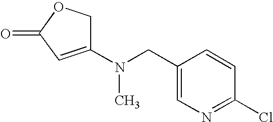 | 8 | 100 |
| according to the invention (84) | | |
| 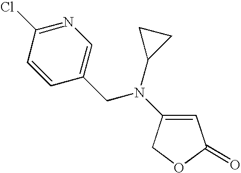 | 8 | 90 |
| according to the invention (88) | | |

### EXAMPLE I

Aphis gossypii test (seed application)

| | |
|---|---|
| Solvent: | 7 parts by weight dimethylformamide |
| Emulsifier: | 10 parts by weight alkylarylpolyglycol ether |

To prepare a suitable active compound preparation 1 part by weight of the active compound is mixed with the given amount of solvent and emulsifier and the concentrate is diluted to the desired concentration with water.

Cotton seeds (Gossypium hirsutum) are treated with the active compound preparation and sown into soil. After ca. 2 week the cotton plants are infected with the cotton aphid (Aphis gossypii). After the desired time the death rate in % is determined. Here 100% means that all aphids were killed; 0% means that no aphids were killed.

The following compounds of the preparation examples, for example, show good activity in this test:

TABLE I
Plant damaging insects
Aphis gossypii (seed application)

| | Active | |
|---|---|---|
| | compound | activity |
| Active | concentration | in % |
| compounds | in g ai/ha | after 7^{d} |
| 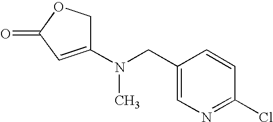 | 4 | 100 |
| according to the invention (84) | | |
| 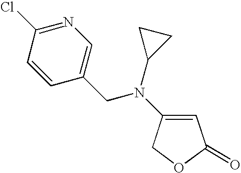 | 4 | 100 |
| according to the invention (88) | | |

### EXAMPLE J

Aphis fabae test (seed application)

| | |
|---|---|
| Solvent: | 7 parts by weight dimethylformamide |
| Emulsifier: | 10 parts by weight alkylarylpolyglycol ether |

To prepare a suitable active compound preparation 1 part by weight of the active compound is mixed with the given amount of solvent and emulsifier and the concentrate is diluted to the desired concentration with water.

Sugar beet seed (Beta vulgaris) is treated with the active compound preparation and sown into soil. After ca. 4 week the beet plants are infected with the black bean aphid (Aphis fabae).

After the desired time the death rate in % is determined. Here 100% means that all aphids were killed; 0% means that no aphids were killed.

The following compound of the preparation examples, for example, shows good activity in this test:

TABLE J
Plant damaging insects
Aphis fabae (seed application)

| | Active compound | Activity |
|---|---|---|
| | concentration | in % |
| Active compounds | in g ai/unit* | after 7^{d} |
| 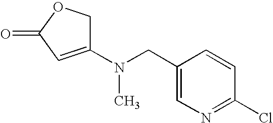 | 90 | 100 |
| according to the invention (84) | | |

*100,000 seeds

### EXAMPLE K

Rhopalosiphon padi test (seed application)

| | |
|---|---|
| Solvent: | 7 parts by weight dimethylformamide |
| Emulsifier: | 10 parts by weight alkylarylpolyglycol ether |

To prepare a suitable active compound preparation 1 part by weight of the active compound is mixed with the given amount of solvent and emulsifier and the concentrate is diluted to the desired concentration with water.

Barley seed (Hordeum vulgare) is treated with the active compound preparation and sown into the soil. After about 1 week the barley plants are infected with the bird cherry-oat aphid (Rhopalosiphon padi).

After the desired time the death rate in % is determined. Here 100% means that all aphids were killed; 0% means that no aphids were killed.

The following compounds of the preparation examples, for example, show good activity in this test:

TABLE K
Plant damaging insects
Rhopalosiphon padi (seed application)

| | Active compound | Activity |
|---|---|---|
| | concentration | in % |
| Active compounds | in g ai/kg | after 7^{d} |
| 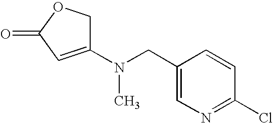 | 1.4 | 100 |
| according to the invention (84) | | |
| 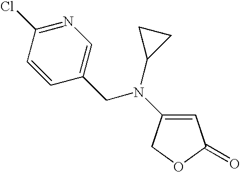 | 1.4 | 100 |
| according to the invention (88) | | |

### EXAMPLE L

Myzus test (spray treatment)

| | |
|---|---|
| Solvent: | 78 parts by weight acetone |
| | 1.5 parts by weight dimethylformamide |
| Emulsifier: | 0.5 parts by weight alkylarylpolyglycol ether |

To prepare a suitable active compound preparation 1 part by weight of the active compound is mixed with the given amount of solvent and emulsifier and the concentrate is diluted to the desired concentration with water containing emulsifier.

Chinese cabbage leaf sections (Brassica pekinensis) infested with all stages of the green peach aphid (Myzus persicae) are sprayed with an active compound preparation at the desired concentration.

After the desired time the activity in % is determined. Here 100% means that all aphids were killed; 0% means that no aphids were killed.

The following compounds of the preparation examples, for example, show good activity in this test:

TABLE L
Plant damaging insects
Myzus test (spray treatment)

| | Active | |
|---|---|---|
| | compound | Death rate |
| | concentration | in % |
| Active compounds | in g/ha | after 5^{d} |
| 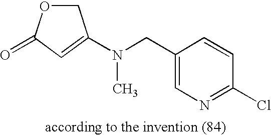 | 500 | 100 |
| 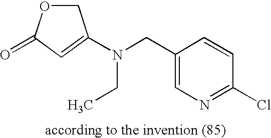 | 500 | 90 |
| 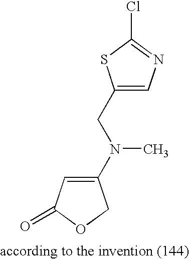 | 500 | 100 |
| 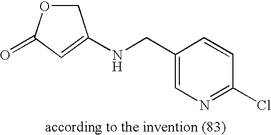 | 500 | 90 |
| 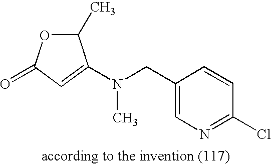 | 500 | 100 |
| 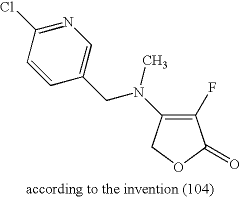 | 500 | 100 |
| 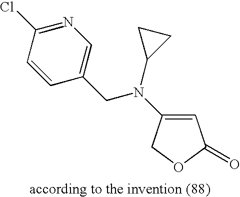 | 500 | 100 |
| 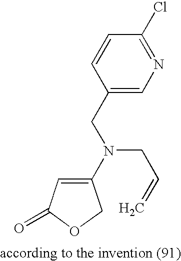 | 500 | 100 |
| 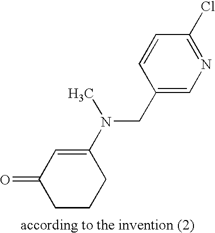 | 500 | 90 |
| 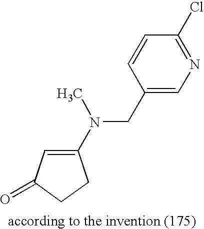 | 500 | 100 |
| 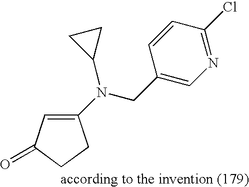 | 500 | 100 |
| 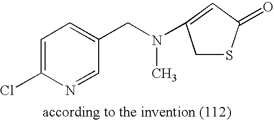 | 500 | 80 |

With an amount applied of in each case 500 g/ha the compounds of examples 1, 98, 94, 147, 125, 121, 4, 9, 10, 124, 126, 92 and 70 showed in each case 100% activity after 5 days, the compound of example 390% activity.

### EXAMPLE M

Phaedon cochleariae test (spray treatment)

| | |
|---|---|
| Solvent: | 78 parts by weight acetone |
| | 1.5 parts by weight dimethylformamide |
| Emulsifier: | 0.5 parts by weight alkylarylpolyglycol ether |

To prepare a suitable active compound preparation 1 part by weight of the active compound is mixed with the given amount of solvent and emulsifier and the concentrate is diluted to the desired concentration with water containing emulsifier.

Chinese cabbage leaf sections (Brassica pekinensis) are sprayed with an active compound preparation at the desired concentration and after drying are infected with larvae of the mustard leaf beetle (Phaedon cochleariae).

After the desired time the activity in % is determined. Here 100% means that all beetle larvae were killed; 0% means that no beetle larvae were killed.

The following compounds of the preparation examples, for example, show good activity in this test:

TABLE M
Plant damaging insects
Phaedon cochleariae test (spray treatment)

| | Active | |
|---|---|---|
| | compound | Death rate |
| | concentration | in % |
| Active compounds | in g/ha | after 7^{d} |
| 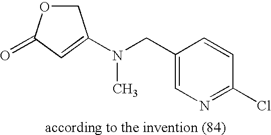 | 500 | 100 |
| 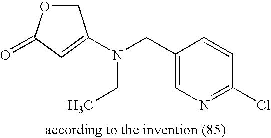 | 500 | 100 |
| 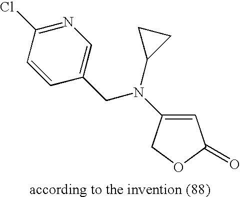 | 500 | 100 |
| 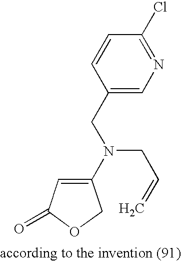 | 500 | 67 |

### EXAMPLE N

Spodoptera frugiperda test (spray treatment)

| | |
|---|---|
| Solvent: | 78 parts by weight acetone |
| | 1.5 parts by weight dimethylformamide |
| Emulsifier: | 0.5 parts by weight alkylarylpolyglycol ether |

To prepare a suitable active compound preparation 1 part by weight of the active compound is mixed with the given amount of solvent and emulsifier and the concentrate is diluted to the desired concentration with water containing emulsifier.

Maize leaf sections (Zea mays) are sprayed with an active compound preparation at the desired concentration and after drying treated with caterpillars of the fall army worm (Spodoptera frugiperda).

After the desired time the activity in % is determined. Here 100% means that all caterpillars were killed; 0% means that no caterpillars were killed.

The following compounds of the preparation examples, for example, show good activity in this test:

TABLE N
Plant damaging insects
Spodoptera frugiperda test (spray treatment)

| | Active | |
|---|---|---|
| | compound | Death rate |
| | concentration | in % |
| Active compounds | in g/ha | after 7^{d} |
| 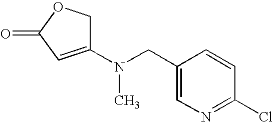 | 500 | 100 |
| according to the invention (84) | | |
| 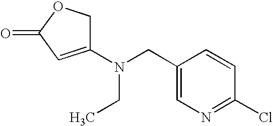 | 500 | 100 |
| according to the invention (85) | | |
| 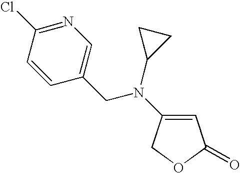 | 500 | 100 |
| according to the invention (88) | | |

At an applied amount of 500 g/ha the compound of example 121 also showed an activity of 100% after 7 days.

### EXAMPLE O

Heliothis virescens test (spray treatment)

| | |
|---|---|
| Solvent: | 78 parts by weight acetone |
| | 1.5 parts by weight dimethylformamide |
| Emulsifier: | 0.5 parts by weight alkylarylpolyglycol ether |

To prepare a suitable active compound preparation 1 part by weight of the active compound is mixed with the given amount of solvent and emulsifier and the concentrate is diluted to the desired concentration with water containing emulsifier.

Soy bean leaves (Glycine max.) are sprayed with an active compound preparation at the desired concentration and after drying were infected with eggs of the cotton boll worm (Heliotis virescens).

After the desired time the activity in % is determined. Here 100% means that all eggs were killed; 0% means that no eggs were killed.

The following compounds of the preparation examples, for example, show good activity in this test:

TABLE O
Plant damaging insects
Heliothis virescens test (spray treatment)

| | Active | |
|---|---|---|
| | compound | Death rate |
| | concentration | in % |
| Active compounds | in g/ha | after 7^{d} |
| 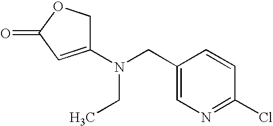 | 500 | 100 |
| according to the invention (85) | | |
| 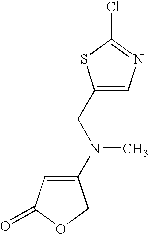 | 500 | 99 |
| according to the invention (144) | | |

### EXAMPLE P

Aphis gossypii test

| | |
|---|---|
| Solvent: | 7 parts by weight dimethylformamide |
| Emulsifier: | 2 parts by weight alkylarylpolyglycol ether |

To prepare a suitable active compound preparation 1 part by weight of the active compound is mixed with the given amount of solvent and emulsifier and the concentrate is diluted to the desired concentration with water containing emulsifier.

Cotton plant leaves (Gossypium hirsutum) heavily infected with the cotton aphid (Aphis gossypii) are treated by immersing in the active compound preparation at the desired concentration. After the desired time the death rate in % is determined. Here 100% means that all aphids were killed; 0% means that no aphids were killed.

The following compound of the preparation examples, for example, shows good activity in this test:

TABLE P
Plant damaging insects
Aphis gossypii test

| | Active | |
|---|---|---|
| | compound | Death rate |
| | concentration | in % |
| Active compounds | in g/ha | after 6^{d} |
| 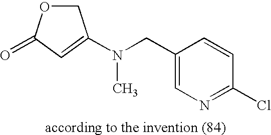 | 100 | 100 |
| 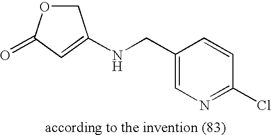 | 100 | 98 |
| 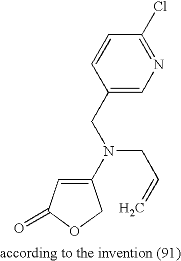 | 100 | 95 |
| 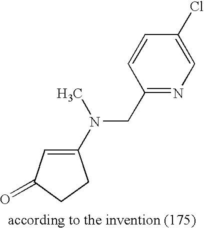 | 100 | 95 |

### EXAMPLE Q

Plutella test

| | |
|---|---|
| Solvent: | 100 parts by weight acetone |
| | 1900 parts by weight methanol |

To prepare a suitable active compound preparation 1 part by weight active compound was mixed with the given amount of solvent and the concentrate was diluted to the desired concentration with methanol.

A given amount of active compound preparation at the desired concentration is pipetted onto a standardised amount of artificial diet. After the methanol has evaporated ca. 200-300 eggs of the diamond back moth (Plutella xylostella) are added to the diet.

After the desired time the death rate of the eggs and larvae, respectively, in % is determined. Here 100% means that all animals were killed; 0% means that no animals were killed.

The following compound of the preparation examples, for example, shows good activity in this test:

TABLE Q
Plant damaging insects
Plutella test

| | Active | |
|---|---|---|
| | compound | Death rate |
| | concentration | in % |
| Active compounds | in g/ha | after 7^{d} |
| 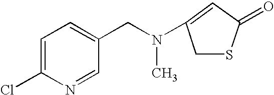 | 1000 | 100 |
| according to the invention (112) | | |

### EXAMPLE R

Myzus persicae test (hydroponic treatment)

| | |
|---|---|
| Solvent: | 7 parts by weight dimethylformamide |
| Emulsifier: | 2 parts by weight alkylarylpolyglycol ether |

To prepare a suitable active compound preparation 1 part by weight of the active compound is mixed with the given amount of solvent and emulsifier and the concentrate is diluted to the desired concentration with water.

The active compound preparation is mixed with water. The concentration given refers to the amount of active compound per unit volume water (mg/l=ppm). The treated water is placed into a vessel with one pea plant (Pisum sativum). After the prescribed time infection with the green peach aphid (Myzus persicae) is carried out.

After the desired time the death rate in % is determined. Here 100% means that all aphids were killed; 0% means that no aphids were killed.

The following compound of the preparation examples, for example, shows good activity in this test:

TABLE R
Plant damaging insects
Myzus persicae-Test (hydroponic treatment)

| | Active compound | Death rate |
|---|---|---|
| | concentration | in % |
| Active compounds | in g/ha | after 7^{d} |
| 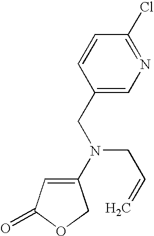 | 20 | 100 |
| according to the invention (91) | | |

At an active compound concentration of in each case 20 ppm the compounds of examples 98, 121 and 125 showed in each case an activity of 100% after 7 days.

### EXAMPLE S

Nilaparvata lugens test; hydroponic treatment (NILALU SYS)

| | |
|---|---|
| Solvent: | 78 parts by weight acetone |
| | 1.5 parts by weight dimethylformamide |
| Emulsifier: | 0.5 parts by weight alkylarylpolyglycol ether |

To prepare a suitable active compound preparation I part by weight of the active compound is mixed with the given amount of solvent and emulsifier and the concentrate is diluted to the desired concentration with water containing emulsifier.

The active compound preparation is pipetted into water. The concentration given refers to the amount of active compound per unit volume (mg/l=ppm). Infection is then carried out with rice brown plant hopper (Nilaparvata lugens).

After the desired time the activity in % is determined. Here 100% means that all plant hoppers were killed; 0% means that no plant hoppers were killed.

In this test the compound of example 1 at an applied amount of 500 g/ha showed an activity of 100% after 7 days.

### EXAMPLE T

Test with cat fleas/oral administration

| | |
|---|---|
| Test animals: | adult Ctenocephalides felis |
| Solvent: | dimethylsulphoxide (DMSO) |

To prepare a suitable formulation a suitable active compound solution was prepared from 10 mg active compound with 0.5 ml DMSO. 10 μl of this formulation was added to 2 ml citrated bovine blood and stirred.

20 fasting adult fleas (Ctenocephalides felis, strain “Georgi”) were placed in a chamber (Ø5 cm) that is closed with cheese cloth at the top and bottom. A metal cylinder the underside of which is closed with Parafilm is placed on the chamber. The cylinder contains the 2 ml blood-active compound formulation which can be consumed by the fleas through the Parafilm membrane.

Whilst the blood is warmed to 37° C. the region of the flea chamber is at room temperature. Controls were carried out with the same volume of DMSO without compound addition.

After the desired time the death rate in % is determined. Here 100% means that all fleas were killed; 0% means that no fleas were killed.

At an active compound concentration of 100 ppm the compound of example 84 achieved a death rate of 100% after 2 days.

### EXAMPLE U

Fly larvae test

| | |
|---|---|
| Test animals: | Lucilia cuprina larvae |
| Solvent: | dimethylsulphoxide |

10 mg active compound were dissolved in 0.5 ml dimethylsulphoxide. To prepare a suitable formulation the active compound solution is diluted with water to the respective desired concentration.

About 20 Lucilia cuprina larvae are placed in a test tube that contains ca. 1 cm³ horse flesh and 0.5 ml of the active compound preparation under test.

After the desired time the death rate in % is determined. Here 100% means that all larvae were killed; 0% means that no larvae were killed.

At a concentration of in each case 100 ppm the compounds of examples 98, 121, 84, 85, 88, 104 and 175 achieved a death rate of 100% after 2 days, the compound of example 125 90%.

### EXAMPLE V

Test with flies

| | |
|---|---|
| Test animals: | adult Musca domestica, strain WHO(N), sensitive |
| Solvent: | dimethylsulphoxide |

10 mg of the active compound are dissolved in 0.5 ml dimethylsulphoxide, lower concentrations are prepared by dilution with water.

0.2 ml of this active compound preparation is pipetted onto a sponge (ca. Ø1.5 cm) that has been wetted with 0.8 ml sugar solution. The sponge and 10 test animals are transferred to a dish (4×4 cm, h 2 cm) and covered.

After 48 hours the activity of the active compound preparation is determined. Here 100% means that all flies were killed; 0% means that no flies were killed.

At an active compounds concentration of in each case 100 ppm the compound of example 84 showed an activity of 80%.

### EXAMPLE W

Test with resistant monoxenous cattle ticks/SP-resistant Parkhurst strain
Injections method
Boophilus microplus (INJ)

| | |
|---|---|
| Test animals: | adult engorged females of Boophilus microplus |
| | (strain Parkhurst-SP resistant) |
| Solvent: | dimethylsulphoxide |

10 mg of the active compound are dissolved in 0.5 ml dimethylsulphoxide, lower concentrations are prepared by dilution with the same solvent.

The test is carried out five times. 1 μl is injected into the abdomen, the animals are transferred into dishes and stored in an air-conditioned room. The control of activity is carried out on a deposit of fertile eggs after 7 days. Eggs, the fertility of which was not visible externally, were stored in glass tubes in an incubator until larvae hatch after about 24 days. An activity of 100% means that no ticks laid fertile eggs.

At an applied amount of in each case 20 μg/animal the compound of example 125 showed an activity of 80%, the compound of example 121 an activity of 95%.

### EXAMPLE X

Cydia pomonella test

| | |
|---|---|
| Solvent: | 4 parts by weight acetone |
| Emulsifier: | 1 parts by weight alkylarylpolyglycol ether |

To prepare a suitable active compound preparation 1 part by weight of the active compound is mixed with the given amount of solvent and emulsifier and the concentrate is diluted to the desired concentration with water.

The active compound preparation was mixed with feed. The concentration given relates to the amount of active compound per unit volume feed (mg/l=ppm). The treated feed is placed in Petri dishes and infected with codling moth larvae (Cydia pomonella).

After the desired time the death rate in % is determined. Here 100% means that all larvae were killed; 0% means that no larvae were killed.

At an active compound concentration of 20 ppm the compound of example 84 caused a death rate of 100% after 7 days, the compound of example 88 a death rate of 90%.

### EXAMPLE Y

Leptinotarsa decemlineata adults test

| | |
|---|---|
| Solvent: | 7 parts by weight dimethylformamide |
| Emulsifier: | 10 parts by weight alkylarylpolyglycol ether |

To prepare a suitable active compound preparation 1 part by weight of the active compound is mixed with the given amount of solvent and emulsifier and the concentrate is diluted to the desired concentration with water containing emulsifier.

Leaves of potato plant (Solanum tuberosum) that are infested with adults of the Colorado beetle, (Leptinotarsa decemlineata) are treated by spraying with the active compound at the desired concentration.

After the desired time the activity in % is determined. Here 100% means that all beetles were killed; 0% means that no beetles were killed.

At an applied amount of in each case 60 g/ha the compounds of examples 84 and 88 showed an activity in each case of 100% after 7 days.

### EXAMPLE Z

Bemisia tabaci test

| | |
|---|---|
| Solvent: | 4 parts by weight acetone |
| Emulsifier: | 1 part by weight alkylarylpolyglycol ether |

To prepare a suitable active compound preparation 1 part by weight of the active compound is mixed with the given amount of solvent and emulsifier and the concentrate is diluted to the desired concentration with water.

The active compound preparation is mixed with earth. The concentration given relates to the amount of active compound per volume unit soil (mg/l=ppm). The treated earth is filled into pots and planted with a cotton plant (Gossypium hirsutum). After a week infection is carried out with white fly (Bemisia tabaci) for egg deposition.

After the desired time the death rate of eggs and larvae, respectively, in % is determined. Here 100% means that all animals were killed; 0% means that no animals that were killed.

At an active compound concentration of in each case 4 ppm the compounds of examples 84 and 88 caused a death rate of in each case 100% after 14 days.

### EXAMPLE A1

Spodoptera frugiperda test

| | |
|---|---|
| Solvent: | 4 parts by weight acetone |
| Emulsifier: | 1 part by weight alkylarylpolyglycol ether |

To prepare a suitable active compound preparation 1 part by weight of the active compound is mixed with the given amount of solvent and emulsifier and the concentrate is diluted to the desired concentration with water.

The active compound preparation is mixed with earth. The concentration given relates to the amount of active compound per unit volume soil (mg/l=ppm). The treated earth is filled into pots and planted with a cotton plant (Gossypium hirsutum). After a week infection is carried out with caterpillars of the fall army worm (Spodoptera frugiperda).

After the desired time the activity in % is determined. Here 100% means that no eating damage is visible, 0% means that eating damage on the treated plants corresponds to that of the controls.

At an active compound concentration of 4 ppm the compound of example 84 showed an activity of 98% (after 7 days).

### EXAMPLE B1

Pulvinaria regalis test

| | |
|---|---|
| Solvent: | 7 parts by weight dimethylformamide |
| Emulsifier: | 10 parts by weight alkylarylpolyglycol ether |

To prepare a suitable active compound preparation 1 part by weight of the active compound is mixed with the given amount of solvent and emulsifier and the concentrate is diluted to the desired concentration with water containing emulsifier.

Chestnut trees (Castaney vesca) that are infested with horse chestnut scale (Pulvinaria regalis) are treated by spraying with the active compound preparation at the desired concentration.

After the desired time the death rate in % is determined. Here 100% means that all animals were killed; 0% means that no animals were killed.

At a concentration of in each case 100 ppm the compound of example 84 caused a death rate of 100% after 30 days, the compound of example 88 a death rate of 95%.

### EXAMPLE C1

Pulvinaria regalis test

| | |
|---|---|
| Solvent: | 4 parts by weight acetone |
| Emulsifier: | 1 part by weight alkylarylpolyglycol ether |

To prepare a suitable active compound preparation 1 part by weight of the active compound is mixed with the given amount of solvent and emulsifier and the concentrate is diluted to the desired concentration with water.

The active compound preparation was poured onto chestnut trees (Castanea vesca). The concentration given relates to the amount of active compound per plant. After a defined time infection was carried out with horse chestnut scale (Pulvinaria regalis).

After the desired time the death rate in % is determined. Here 100% means that all animals were killed; 0% means that no animals were killed.

At an applied amount of 10 mg per plant the compound of example 84 caused a death rate of 100% after 30 days.

### EXAMPLE D1

Aphis fabae test (seed application)

| | |
|---|---|
| Solvent: | 7 parts by weight dimethylformamide |
| Emulsifier: | 10 parts by weight alkylarylpolyglycol ether |

To prepare a suitable active compound preparation 1 part by weight of the active compound is mixed with the given amount of solvent and emulsifier and the concentrate is diluted to the desired concentration with water.

Sugar beet seed (Beta vulgaris) is treated with the active compound preparation and sown into the earth. After ca. 4 weeks the beet plants are infected with the black bean aphid (Aphis fabae).

After the desired time the death rate in % is determined. Here 100% means that all aphids were killed; 0% means that no aphids were killed.

At an applied amount of 90 g per unit (100,000 seeds) the compound of example 88 caused a death rate of 100% after 7 days.

### EXAMPLE E1

### Odontotermes Test

### Open Land (Spray Treatment)

To prepare a suitable active compound preparation 1 part by weight of the active compound is mixed with the given amount of water to the desired concentration.

Areas of wood of the obeche tree (Triplochiton scleroxylon) are treated by spraying with the active compound preparation at the desired concentration and infected with termites (Odontotermes sp.).

After the desired time the activity in % is determined. Here 100% means that the wood was not infested by termites; 0% means that the wood was infested by termites.

At an applied amount of 240 g/ha the compound of example 84 showed an activity of 99% after 45 days, the compound of example 88 showed an activity of 95% after 65 days.

### EXAMPLE F1

### Bemisia tabaci Test

### Open Land (Spray Treatment)

To prepare a suitable active compound preparation 1 part by weight of the active compound is mixed with the given amount of water to the desired concentration.

Paprika plants (Capsicum annuum) that are infested with all stages of the white fly (Bemisia tabaci) are sprayed with an active compound preparation at the desired concentration.

After the desired time the death rate in % is determined. Here 100% means that all white fly were killed; 0% means that no white fly were killed.

At an applied amount of 300 g/ha the compounds of examples 84 and 88 caused a death rate in each case of 93% after 65 days.

### EXAMPLE G1

### Thrips tabaci Test

### Open Land (Spray Treatment)

To prepare a suitable active compound preparation 1 part by weight of the active compound is mixed with the given amount of water to the desired concentration.

Onions (Allium cepa) that are infested with all stages of the onion thrips (Thrips tabaci) are sprayed with an active compound preparation at the desired concentration.

After the desired time the death rate in % is determined. Here 100% means that all thrips were killed; 0% means that no thrips were killed.

At an applied amount of 300 g/ha the compound of example 84 caused a death rate of 89% after 14 days, the compound of example 88 a death rate 98%.

### EXAMPLE H1

### Piezodorus guildingi Test

### Open Land (Spray Treatment)

To prepare a suitable active compound preparation 1 part by weight of the active compound is mixed with the given amount of water to the desired concentration.

Soy bean plants (Glycine max) infested with the adults of the green stink bug (Piezodorus guildingi) are treated with an active compound preparation at the desired concentration.

After the desired time the death rate in % is determined. Here 100% means that all bugs were killed; 0% means that no bugs were killed.

At an applied amount of 300 g/ha the compound of example 84 caused a death rate of 100% after 11 days.

### EXAMPLE I1

### Nilaparvata lugens Test

### Open Land (Spray Treatment)

To prepare a suitable active compound preparation 1 part by weight of the active compound is mixed with the given amount of water to the desired concentration.

Rice plants (Oryza sativa) that are infested with all stages of the brown plant hopper (Nilaparvata lugens) are sprayed with an active compound preparation at the desired concentration.

After the desired time the death rate in % is determined. Here 100% means that all plant hoppers were killed; 0% means that no plant hoppers were killed.

At an applied amount of 300 g/ha the compound of example 84 caused a death rate of 91% after 14 days, the compound of example 88 a death rate of 99%.

### EXAMPLE J1

### Brevicoryne brassicae Test

### Open Land (Spray Treatment)

To prepare a suitable active compound preparation 1 part by weight of the active compound is mixed with the given amount of water to the desired concentration.

Cabbage plants (Brassica oleracea) that are infested with all stages of the mealy cabbage aphid (Brevicoryne brassicae) are sprayed with an active compound preparation at the desired concentration.

After the desired time the death rate in % is determined. Here 100% means that all aphids were killed; 0% means that no aphids were killed.

At an applied amount of 300 g/ha the compounds of examples 84 and 88 caused in each case a death rate of 99% after 22 days.

### EXAMPLE K1

### Nephotettix sp. Test

### Open Land (Spray Treatment)

To prepare a suitable active compound preparation 1 part by weight of the active compound is mixed with the given amount of water to the desired concentration.

Rice plants (Oryza sativa) that are infested with all stages of the green leaf hopper (Nephotettix sp.) are sprayed with an active compound preparation at the desired concentration.

After the desired time the death rate in % is determined. Here 100% means that all leaf hoppers were killed; 0% means that no leaf hoppers were killed.

At an applied concentration of 300 g/ha the compounds of examples 84 and 88 caused a death rate of 98 and 99%, respectively, after 15 days.

### EXAMPLE L1

### Brevicoryne brassicae Test

### Open Land (Drench Application)

To prepare a suitable active compound preparation 1 part by weight of the active compound is mixed with the given amount of water to the desired concentration.

Cabbage plants (Brassica oleracea) that are infested with all stages of the mealy cabbage aphid (Brevicoryne brassicae) are drenched with an active compound preparation at the desired concentration.

After the desired time the death rate in % is determined. Here 100% means that all aphids were killed; 0% means that no aphids were killed.

At an applied amount of 0.04 g/plant the compounds of examples 84 and 88 caused a death rate of 100 and 97%, respectively, after 35 days.

### EXAMPLE M1

### Brevicoryne brassicae Test

### Open Land (Spray Treatment)

To prepare a suitable active compound preparation 1 part by weight of the active compound is mixed with the given amount of water to the desired concentration.

Cabbage plants (Brassica oleracea) that are infested with all stages of the mealy cabbage aphid (Brevicoryne brassicae) are sprayed with an active compound preparation at the desired concentration.

After the desired time the death rate in % is determined. Here 100% means that all nymphs were killed; 0% means that no nymphs were killed.

At an applied amount of 300 g/ha the compounds of examples 84 and 88 caused a death rate of 96 and 99%, respectively, after 28 days.

1. A method of controlling plant pests comprising contacting a plant, a seed or soil with a compound of structure (I) 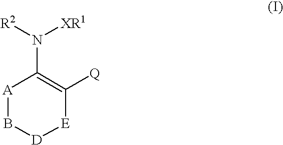
in which
R¹ stands for an unsubstituted or substituted 5- or 6-membered aromatic heterocycle that contains nitrogen,
X stands for in each case an unsubstituted or substituted alkylene or alkylidene,
R² stands for hydrogen, or in each case unsubstituted or substituted alkyl, alkenyl, cycloalkyl, cycloalkenyl, or aryl, or YR³, wherein
Y stands for oxygen, S(O)ₙ, CO or CO₂,
n stands for 0, 1 or 2,
R³ stands for hydrogen or in each case unsubstituted or substituted alkyl, alkenyl, alkynyl, cycloalkyl, cycloalkenyl or aryl,
A, B and D independently of each other stand in for each case for an unsubstituted or substituted carbon atom or heteroatom, or a single bond,
E stands for CO or CS,
Q stands for hydrogen or for in each case unsubstituted or substituted alkyl, alkenyl, alkynyl or aryl, or for nitro, halogen or Z-R⁴,
Z stands for CO, CO² or S(O)ₘ,
m stands for 0, 1 or 2 and
R⁴ stands for in each case unsubstituted or substituted alkyl, alkenyl, alkynyl, cycloalkyl, cycloalkenyl or aryl.

2. The method according to claim 1 wherein said compound of structure (I) is applied to a seed.

3. The method according to claim 1 wherein said compound of structure (I) is applied to soil.

4. The method according to claim 1 wherein said plant pest is a zoopest.

5. The method according to claim 1 wherein said plant pest is a house fly.

6. The method according to claim 1 wherein said plant pest is a cockroach.

7. The method according to claim 1 wherein said compound of structure (I) is applied to a plant.

8. The method according to claim 2 wherein said seed is a transgenic seed.

9. The method according to claim 2 wherein a plant is emerging from said seed.

10. The method according to claim 7 wherein said compound of structure (I) is applied through a stem of said plant.
